(19) United States
(12) Patent Application Publication
(10) Pub. No.: US 2024/0397393 A1
(43) Pub. Date: Nov. 28, 2024

(54) METHOD AND DEVICE USED IN COMMUNICATION NODE FOR WIRELESS COMMUNICATION

(71) Applicants: Qiaoling YU, Shanghai (CN); Xiaobo ZHANG, Shanghai (CN)

(72) Inventors: Qiaoling YU, Shanghai (CN); Xiaobo ZHANG, Shanghai (CN)

(73) Assignee: SHANGHAI LANGBO COMMUNICATION TECHNOLOGY COMPANY LIMITED, Shanghai, OT (CN)

(21) Appl. No.: 18/770,683

(22) Filed: Jul. 12, 2024

Related U.S. Application Data
(63) Continuation of application No. PCT/CN2023/072013, filed on Jan. 13, 2023.

(30) Foreign Application Priority Data
Jan. 18, 2022 (CN) 202210054782.1

(51) Int. Cl. H04W 36/00; H04W 36/08

(52) U.S. Cl. CPC H04W 36/00837; H04W 36/0061; H04W 36/08

(57) ABSTRACT

The present application discloses a method and a device in a communication node for wireless communications. The communication node receives a first signaling, the first signaling indicating a first condition set, the first condition set including multiple triggering conditions; and as a response to a first triggering condition being satisfied, disconnects from a first serving cell and applies a first candidate configuration, the first candidate configuration including configuration information for a second serving cell, the first serving cell and the second serving cell each being a SpCell; the first triggering condition being satisfied occurs after receiving the first signaling, the first triggering condition is a triggering condition in a first condition subset, and the first condition subset is a proper subset of the first condition set; the first condition subset is related to the first serving cell.

### CROSS REFERENCE TO RELATED APPLICATIONS

This application is the continuation of the international patent application No. PCT/CN2023/072013, filed on January 13,2023, and claims the priority benefit of Chinese Patent Application No. 202210054782.1, filed on January 18,2022, the full disclosure of which is incorporated herein by reference.

### BACKGROUND

### Technical Field

The present application relates to transmission methods and devices in wireless communication systems, and in particular to a transmission method and device for mobility.

### Related Art

3GPP supports User Equipment (UE) to configure SCG in RRC (i.e., Radio Resource Control) connected state (also referred to as RRC_Connected), and R17 (Release 16) introduces the change of Primary SCG (PSCell) based on conditional reconfiguration, i.e., Conditional PSCell Change (CPC).

### SUMMARY

In the existing protocol, the base station configures at least one candidate cell for the UE, and configures execution conditions and candidate configurations for each candidate cell, applies the candidate configurations when the execution conditions of a candidate cell are satisfied, and deletes the configuration information of the configured candidate cell if the candidate cell is successfully accessed. If the CPC is not reconfigured, the UE cannot perform subsequent CPC, which increases the delay and signaling overhead incurred by changing the cell, especially in FR2 environment where PSCell changes are more frequent. Therefore, enhancements are required for successive PSCell changes.

To address the above problem, the present application provides a solution. In the description of the above problem, New Radio (NR) scenario is used as an example: the present application is equally applicable to scenarios such as Long Term Evolution (LTE) or Sidelink (SL), where similar technical effect can be achieved. Additionally, the adoption of a unified solution for various scenarios contributes to the reduction of hardcore complexity and costs.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict.

The present application provides a method in a first node for wireless communications, comprising:
receiving a first signaling, the first signaling being used to indicate a first condition set, the first condition set including multiple triggering conditions; and
as a response to a first triggering condition being satisfied, disconnecting from a first serving cell and applying a first candidate configuration, the first candidate configuration including configuration information for a second serving cell, the first serving cell and the second serving cell each being a SpCell (i.e., Special Cell);
herein, the first triggering condition being satisfied occurs after receiving the first signaling, the first triggering condition is a triggering condition in a first condition subset, and the first condition subset is a proper subset of the first condition set: the first condition subset is related to the first serving cell.

In one embodiment, a problem to be solved in the present application includes: how to realize continuous PSCell changes.

In one embodiment, a problem to be solved in the present application includes: how to ensure accurate PSCell changes.

In one embodiment, a problem to be solved in the present application includes: how to shorten the delay.

In one embodiment, a problem to be solved in the present application includes: how to reduce signaling overhead.

In one embodiment, characteristics of the above method include that the first serving cell is a serving cell of the first node, and triggering conditions in a first condition subset in the first condition set are evaluated.

In one embodiment, characteristics of the above method include that the first serving cell is a serving cell of the first node, and a first condition subset in the first condition set is in effect.

In one embodiment, characteristics of the above method include that before completing the application of a first candidate configuration, no triggering condition in any condition subset associated with the second serving cell in the first condition set is to be evaluated.

In one embodiment, characteristics of the above method include that after completing the application of the first candidate configuration, the configuration of the first serving cell is not deleted.

In one embodiment, characteristics of the above method include that after completing the application of the first candidate configuration, a triggering condition in a condition subset associated with the second serving cell in the first condition set is to be evaluated.

In one embodiment, characteristics of the above method include that after completing the application of the first candidate configuration, a condition subset associated with the second serving cell in the first condition set takes effect.

In one embodiment, an advantage of the above method includes: how to realize successive PSCell changes.

In one embodiment, an advantage of the above method includes: how to ensure accurate PSCell changes.

In one embodiment, an advantage of the above method includes: how to shorten latency.

In one embodiment, an advantage of the above method includes: how to reduce signaling overhead.

According to one aspect of the present application, characterized in that the first condition set includes Q1 condition subsets, and the first serving cell is one of Q1 cells, the Q1 condition subsets being respectively associated with the Q1 cells, Q1 being a positive integer greater than 1.

According to one aspect of the present application, characterized in comprising:
synchronizing to the second serving cell as a response to the first triggering condition being satisfied.

According to one aspect of the present application, characterized in comprising:
transmitting a third signaling:
herein, the third signaling includes information being used to confirm successful access to the second serving cell.

According to one aspect of the present application, characterized in that the first triggering condition comprises that at least a measurement result for the second serving cell is greater than a first threshold; the first signaling comprises the first threshold: the first threshold is configured by a maintenance base station of the first serving cell.

According to one aspect of the present application, characterized in that the first triggering condition comprises that at least a measurement result for the second serving cell is greater than a first threshold; the first signaling comprises the first threshold: the first threshold is configured by a maintenance base station of the second serving cell.

According to one aspect of the present application, characterized in comprising:
as a response to a second triggering condition being satisfied, disconnecting from a third serving cell and applying a second candidate configuration, the second candidate configuration including configuration information for the first serving cell, the third serving cell being a SpCell:
herein, the action of receiving the first signaling occurs before the second triggering condition being satisfied.

According to one aspect of the present application, characterized in comprising:
receiving a second signaling, the second signaling being used to indicate the first condition set:
herein, the action of receiving the second signaling occurs after the second triggering condition being satisfied.

According to one aspect of the present application, characterized in comprising:
synchronizing to the first serving cell as a response to the second triggering condition being satisfied; and transmitting a fourth signaling:
herein, the fourth signaling includes information being used to confirm successful access to the first serving cell.

According to one aspect of the present application, characterized in that the second triggering condition comprises that at least a measurement result for the first serving cell is greater than a second threshold; the first signaling comprises the second threshold: the second threshold is configured by a maintenance base station of the third serving cell.

According to one aspect of the present application, characterized in that the second triggering condition comprises that at least a measurement result for the first serving cell is greater than a second threshold; the first signaling comprises the second threshold: the second threshold is configured by a maintenance base station of the first serving cell.

According to one aspect of the present application, characterized in that a cell group identity of a cell group to which the first serving cell belongs is configured as a first integer, and a cell group identity of a cell group to which the second serving cell belongs is configured as the first integer.

According to one aspect of the present application, characterized in that the first condition subset includes Q2 triggering conditions, and the second serving cell is one of Q2 cells, the Q2 triggering conditions being respectively associated with the Q2 cells, Q2 being a positive integer greater than 1.

According to one aspect of the present application, characterized in comprising:
evaluating a second condition subset after successful application of the first candidate configuration: herein, the second condition subset is a proper subset of the first condition set: the second condition
subset is related to the second serving cell.

The present application provides a method in a second node for wireless communications, comprising:
transmitting a first signaling, the first signaling being used to indicate a first condition set, the first condition set including multiple triggering conditions:
herein, as a response to a first triggering condition being satisfied, a first serving cell is disconnected
and a first candidate configuration is applied, the first candidate configuration including configuration information for a second serving cell, the first serving cell and the second serving cell each being a SpCell: the first triggering condition being satisfied occurs after receiving the first signaling, the first triggering condition is a triggering condition in a first condition subset, and the first condition subset is a proper subset of the first condition set: the first condition subset is related to the first serving cell.

According to one aspect of the present application, characterized in that the first condition set includes Q1 condition subsets, and the first serving cell is one of Q1 cells, the Q1 condition subsets being respectively associated with the Q1 cells, Q1 being a positive integer greater than 1.

According to one aspect of the present application, characterized in that as a response to the first triggering condition being satisfied, a receiver of the first signaling is synchronized to the second serving cell: a third signaling is transmitted by the receiver of the first signaling: where the third signaling includes information that is used to confirm successful access to the second serving cell.

According to one aspect of the present application, characterized in comprising:
receiving the third signaling; and
transmitting a fifth signaling:
herein, the third signaling is used to trigger the fifth signaling, the fifth signaling comprising at least a portion of the third signaling, a receiver of the fifth signaling being a maintenance base station of the second serving cell.

According to one aspect of the present application, characterized in that the first triggering condition comprises that at least a measurement result for the second serving cell is greater than a first threshold; the first signaling comprises the first threshold: the first threshold is configured by a maintenance base station of the first serving cell, or, the first threshold is configured by a maintenance base station of the second serving cell.

According to one aspect of the present application, characterized in comprising:
receiving the first threshold;
herein, the first threshold is configured by a maintenance base station of the second serving cell.

According to one aspect of the present application, characterized in that as a response to a second triggering condition being satisfied, a third serving cell is disconnected and a second candidate configuration is applied, the second candidate configuration including configuration information for the first serving cell, the third serving cell being a SpCell: where the action of receiving the first signaling occurs before the second triggering condition being satisfied.

According to one aspect of the present application, characterized in that a second signaling is received, the second signaling being used to indicate the first condition set; herein, the action of receiving the second signaling occurs after the second triggering condition being satisfied.

According to one aspect of the present application, characterized in comprising:
transmitting a second signaling.

According to one aspect of the present application, characterized in that as a response to the second triggering condition being satisfied, a receiver of the first signaling is synchronized to the first serving cell: a fourth signaling is transmitted; where the fourth signaling includes information that is used to confirm successful access to the first serving cell.

According to one aspect of the present application, characterized in comprising:
receiving a fourth signaling:
transmitting a sixth signaling:
herein, the fourth signaling is used to trigger the sixth signaling, the sixth signaling comprising at least a portion of the fourth signaling, a receiver of the sixth signaling being a maintenance base station of the first serving cell.

According to one aspect of the present application, characterized in that the second triggering condition comprises that at least a measurement result for the first serving cell is greater than a second threshold: the first signaling comprises the second threshold: the second threshold is configured by a maintenance base station of the third serving cell, or, the second threshold is configured by a maintenance base station of the first serving cell.

According to one aspect of the present application, characterized in comprising:
receiving the second threshold:
herein, the second threshold is configured by a maintenance base station of the first serving cell.

According to one aspect of the present application, characterized in that a cell group identity of a cell group to which the first serving cell belongs is configured as a first integer, and a cell group identity of a cell group to which the second serving cell belongs is configured as the first integer.

According to one aspect of the present application, characterized in that the first condition subset includes Q2 triggering conditions, and the second serving cell is one of Q2 cells, the Q2 triggering conditions being respectively associated with the Q2 cells, Q2 being a positive integer greater than 1.

According to one aspect of the present application, characterized in that a second condition subset is evaluated after successful application of the first candidate configuration: herein, the second condition subset is a proper subset of the first condition set: the second condition subset is related to the second serving cell.

The present application provides a method in a third node for wireless communications, comprising:
a receiver of a first signaling synchronizing to a second serving cell as a response to a first triggering condition being satisfied:
herein, the first signaling is used to indicate a first condition set, the first condition set including multiple triggering conditions: as a response to a first triggering condition being satisfied, a first serving cell is disconnected and a first candidate configuration is applied, the first candidate configuration including configuration information for the second serving cell, the first serving cell and the second serving cell each being a SpCell: the first triggering condition being satisfied occurs after receiving the first signaling, the first triggering condition is a triggering condition in a first condition subset, and the first condition subset is a proper subset of the first condition set: the first condition subset is related to the first serving cell.

According to one aspect of the present application, characterized in that the first condition set includes Q1 condition subsets, and the first serving cell is one of Q1 cells, the Q1 condition subsets being respectively associated with the Q1 cells, Q1 being a positive integer greater than 1.

According to one aspect of the present application, characterized in comprising:
receiving a third signaling:
herein, the third signaling includes information being used to confirm successful access to the second serving cell.

According to one aspect of the present application, characterized in comprising:
receiving a fifth signaling:
herein, a third signaling is used to trigger the fifth signaling, the third signaling comprising information being used to confirm successful access to the second serving cell: the fifth signaling comprises at least a portion of the third signaling, a receiver of the fifth signaling being a maintenance base station of the second serving cell.

According to one aspect of the present application, characterized in that the first triggering condition comprises that at least a measurement result for the second serving cell is greater than a first threshold: the first signaling comprises the first threshold: the first threshold is configured by a maintenance base station of the first serving cell, or, the first threshold is configured by a maintenance base station of the second serving cell.

According to one aspect of the present application, characterized in comprising:
transmitting the first threshold:
herein, the first threshold is configured by a maintenance base station of the second serving cell.

According to one aspect of the present application, characterized in that as a response to a second triggering condition being satisfied, a third serving cell is disconnected and a second candidate configuration is applied, the second candidate configuration including configuration information for the first serving cell, the third serving cell being a SpCell: where the action of receiving the first signaling occurs before the second triggering condition being satisfied.

According to one aspect of the present application, characterized in that a second signaling is received, the second signaling being used to indicate the first condition set: herein, the action of receiving the second signaling occurs after the second triggering condition being satisfied.

According to one aspect of the present application, characterized in that as a response to the second triggering condition being satisfied, a receiver of the first signaling is synchronized to the first serving cell: a fourth signaling is transmitted: where the fourth signaling includes information that is used to confirm successful access to the first serving cell.

According to one aspect of the present application, characterized in that the fourth signaling is used to trigger the sixth signaling, the sixth signaling comprising at least a portion of the fourth signaling, a receiver of the sixth signaling being a maintenance base station of the first serving cell.

According to one aspect of the present application, characterized in that the second triggering condition comprises that at least a measurement result for the first serving cell is greater than a second threshold: the first signaling comprises the second threshold: the second threshold is configured by a maintenance base station of the third serving cell, or, the second threshold is configured by a maintenance base station of the first serving cell.

According to one aspect of the present application, characterized in that a cell group identity of a cell group to which the first serving cell belongs is configured as a first integer, and a cell group identity of a cell group to which the second serving cell belongs is configured as the first integer.

According to one aspect of the present application, characterized in that the first condition subset includes Q2 triggering conditions, and the second serving cell is one of Q2 cells, the Q2 triggering conditions being respectively associated with the Q2 cells, Q2 being a positive integer greater than 1.

According to one aspect of the present application, characterized in that a second condition subset is evaluated after successful application of the first candidate configuration: herein, the second condition subset is a proper subset of the first condition set: the second condition subset is related to the second serving cell.

The present application provides a first node for wireless communications, comprising:
a first receiver, receiving a first signaling, the first signaling being used to indicate a first condition set, the first condition set including multiple triggering conditions; and
a first processor, as a response to a first triggering condition being satisfied, disconnecting from a first
serving cell and applying a first candidate configuration, the first candidate configuration including configuration information for a second serving cell, the first serving cell and the second serving cell each being a SpCell:
herein, the first triggering condition being satisfied occurs after receiving the first signaling, the first triggering condition is a triggering condition in a first condition subset, and the first condition subset is a proper subset of the first condition set: the first condition subset is related to the first serving cell.

In one embodiment, the first processor comprises at least one processing device.

In one embodiment, the first processor comprises at least one transmitter.

In one embodiment, the first processor comprises at least one receiver.

In one embodiment, the first processor comprises at least one of the first receiver or the first transmitter.

The present application provides a second node for wireless communications, comprising:
a first transmitter, transmitting a first signaling, the first signaling being used to indicate a first condition set, the first condition set including multiple triggering conditions:
herein, as a response to a first triggering condition being satisfied, a first serving cell is disconnected and a first candidate configuration is applied, the first candidate configuration including configuration information for a second serving cell, the first serving cell and the second serving cell each being a SpCell; the first triggering condition being satisfied occurs after receiving the first signaling, the first triggering condition is a triggering condition in a first condition subset, and the first condition subset is a proper subset of the first condition set; the first condition subset is related to the first serving cell.

The present application provides a third node for wireless communications, comprising:
a third processor, with a receiver of a first signaling synchronizing to a second serving cell as a response to a first triggering condition being satisfied:
herein, the first signaling is used to indicate a first condition set, the first condition set including multiple triggering conditions: as a response to a first triggering condition being satisfied, a first serving cell is disconnected and a first candidate configuration is applied, the first candidate configuration including configuration information for the second serving cell, the first serving cell and the second serving cell each being a SpCell: the first triggering condition being satisfied occurs after receiving the first signaling, the first triggering condition is a triggering condition in a first condition subset, and the first condition subset is a proper subset of the first condition set: the first condition subset is related to the first serving cell.

In one embodiment, the third processor comprises at least one processing device.

In one embodiment, the third processor comprises at least one transmitter.

In one embodiment, the third processor comprises at least one receiver.

In one embodiment, the third processor comprises at least one of the third receiver or the third transmitter.

In one embodiment, compared with the prior art, the present application is advantageous in the following aspects:
how to realize successive PSCell changes:
how to ensure accurate PSCell changes:
how to shorten latency:
how to reduce signaling overhead.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of transmission of a first signaling according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of radio signal transmission according to one embodiment of the present application.

FIG. 6 illustrates a flowchart of radio signal transmission according to another embodiment of the present application.

FIG. 7 illustrates a flowchart of radio signal transmission of a first threshold according to one embodiment of the present application.

FIG. 8 illustrates a flowchart of radio signal transmission of a second threshold according to one embodiment of the present application.

FIG. 9 illustrates a flowchart of radio signal transmission of evaluating a second condition subset after successful application of a first candidate configuration according to one embodiment of the present application.

FIG. 10 illustrates a schematic diagram of a first condition set including Q1 condition subsets according to one embodiment of the present application.

FIG. 11 illustrates a schematic diagram of the structure of an information block according to one embodiment of the present application.

FIG. 12 illustrates a schematic diagram of the structure of an information block according to another embodiment of the present application.

FIG. 13 illustrates a schematic diagram of a cell group identity of a cell group to which a first serving cell belongs and a cell group identity of a cell group to which a second serving cell belongs being configured as a first integer according to one embodiment of the present application.

FIG. 14 illustrates a schematic diagram of a first condition subset including Q2 triggering conditions according to one embodiment of the present application.

FIG. 15 illustrates a structure block diagram of a processing device used in a first node according to one embodiment of the present application.

FIG. 16 illustrates a structure block diagram of a processing device used in a second node according to one embodiment of the present application.

FIG. 17 illustrates a structure block diagram of a processing device used in a third node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

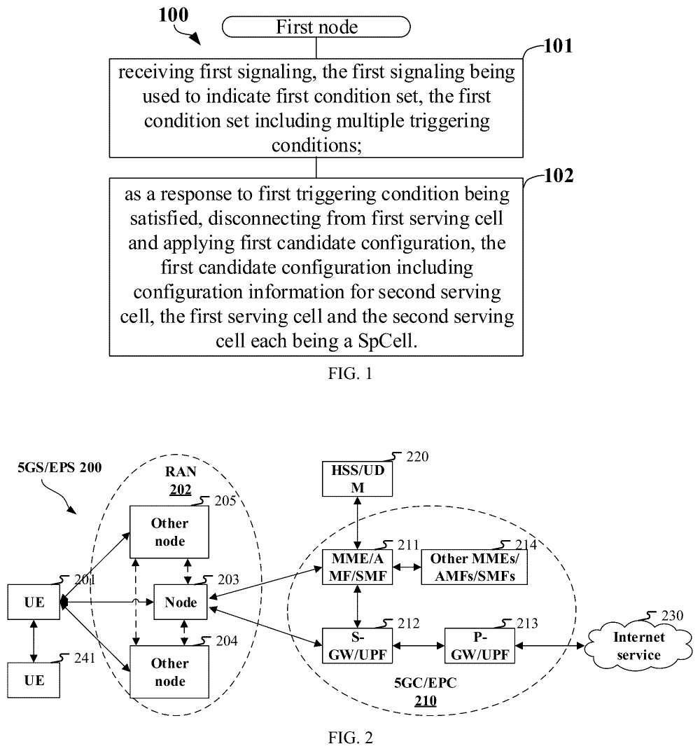

Embodiment 1 illustrates a flowchart of transmission of a first signaling according to one embodiment of the present application, as shown in FIG. 1. In FIG. 1, each step represents a step, it should be particularly noted that the sequence order of each box herein does not imply a chronological order of steps marked respectively by these boxes.

In Embodiment 1, the first node in the present application receives a first signaling in step 101, the first signaling being used to indicate a first condition set, the first condition set including multiple triggering conditions; and in step 102, as a response to a first triggering condition being satisfied, disconnects from a first serving cell and applies a first candidate configuration, the first candidate configuration including configuration information for a second serving cell, the first serving cell and the second serving cell each being a SpCell: herein, the first triggering condition being satisfied occurs after receiving the first signaling, the first triggering condition is a triggering condition in a first condition subset, and the first condition subset is a proper subset of the first condition set: the first condition subset is related to the first serving cell.

In one embodiment, the first condition set comprises two triggering conditions.

In one embodiment, the first condition set comprises at least two triggering conditions.

In one embodiment, the first condition set is for a Primary Cell (PCell), and the SpCell is a PCell.

In one subembodiment, the first signaling is used to configure Conditional Handover (CHO).

In one subembodiment, the first signaling is used to configure a candidate MCG.

In one subembodiment, the first signaling is used to configure a candidate PCell.

In one embodiment, the first condition set is for a PSCell and the SpCell is a PSCell.

In one subembodiment, the first signaling is used to configure CPC.

In one subembodiment, the first signaling is used to configure CPC or Conditional PSCell Addition (CPA).

In one subembodiment, the first signaling is used to configure a candidate Secondary Cell Group (SCG).

In one subembodiment, the first signaling is used to configure a candidate PSCell.

In one embodiment, a transmitter of the first signaling includes only one node.

In one embodiment, a transmitter of the first signaling includes multiple nodes.

In one embodiment, a transmitter of the first signaling includes a source Secondary Node (SN).

In one embodiment, a transmitter of the first signaling includes a source Master Node (MN).

In one embodiment, a transmitter of the first signaling includes a current serving base station for the first node.

In one embodiment, a transmitter of the first signaling includes a maintenance base station for the first serving cell.

In one embodiment, a transmitter of the first signaling includes a maintenance base station for a PCell.

In one embodiment, the first signaling comprises an RRC message.

In one embodiment, the first signaling comprises at least one RRC message.

In one embodiment, the first signaling is an RRC message.

In one embodiment, the first signaling is multiple RRC messages.

In one embodiment, the first signaling comprises at least one RRC Information Element (IE).

In one embodiment, the first signaling comprises at least one RRC Field.

In one embodiment, the first signaling comprises at least one sub-signaling, each sub-signaling of the at least one sub-signaling being an RRC message, and each sub-signaling being used to indicate at least one triggering condition, the multiple triggering conditions in the first condition set including the at least one triggering condition.

In one embodiment, any two of the at least one sub-signaling are received simultaneously.

In one embodiment, any two of the at least one sub-signaling are not received simultaneously.

In one embodiment, the first signaling is a RRCReconfiguration message.

In one embodiment, the first signaling is a RRCConnectionReconfiguration message.

In one embodiment, the first signaling comprises at least one RRCReconfiguration message.

In one embodiment, the first signaling comprises at least one RRCConnectionReconfiguration message.

In one embodiment, the first signaling comprises at least one MeasId.

In one embodiment, the phrase the first signaling being used to indicate a first condition set comprises: the first signaling indicating at least one condition subset in the first condition set.

In one embodiment, the phrase the first signaling being used to indicate a first condition set comprises: the first signaling indicating at least one triggering condition in the first condition set.

In one embodiment, the phrase the first signaling being used to indicate a first condition set comprises: the first signaling indicating all conditions in the first condition set.

In one embodiment, the phrase the first signaling being used to indicate a first condition set comprises: the first signaling indicating part of conditions in the first condition set.

In one embodiment, the first signaling explicitly indicates the first condition set.

In one embodiment, the first signaling implicitly indicates the first condition set.

In one embodiment, the first signaling indicates the first triggering condition.

In one embodiment, the first signaling indicates the first condition subset.

In one embodiment, the first signaling includes a list of conditions, the list of conditions being used to determine the first condition set, with each entry in the list of conditions corresponding to a triggering condition in the first condition set.

In one embodiment, the first signaling indicates a measurement identifier (measureId) associated with each triggering condition of the multiple triggering conditions in the first condition set.

In one embodiment, the first signaling indicates a triggering event associated with each triggering condition of the multiple triggering conditions in the first condition set.

In one embodiment, the first signaling includes the first candidate configuration.

In one embodiment, the first signaling indicates the first candidate configuration.

In one embodiment, the first signaling includes an RRC field, the RRC field including the first candidate configuration.

In one embodiment, the first signaling includes an RRC field, the RRC field including an RRC message, the RRC message including the first candidate configuration.

In one embodiment, the first signaling includes a ReconfigurationWithSync field, the Reconfiguration WithSync field indicating the first candidate configuration, the Reconfiguration WithSync field including a PCI of the second serving cell.

In one embodiment, the first signaling includes a ConditionalReconfiguration IE, the ConditionalReconfiguration IE including the first candidate configuration.

In one embodiment, the first signaling includes a ConditionalReconfigToAddModList IE, the ConditionalReconfigToAddModList IE including the first candidate configuration.

In one embodiment, the first signaling includes a condRRCReconfig field, the condRRCReconfig field including the first candidate configuration.

In one embodiment, the first signaling includes a CellGroupConfig IE, the CellGroupConfig IE including the first candidate configuration.

In one embodiment, the first signaling includes a CellGroupConfig IE, the CellGroupConfig IE including the first candidate configuration, the CellGroupConfig IE belonging to a masterCellGroup field.

In one embodiment, the first signaling includes a CellGroupConfig IE, the CellGroupConfig IE including the first candidate configuration, the CellGroupConfig IE belonging to a secondary CellGroup field.

In one embodiment, the first signaling includes ServingCellConfigCommon.

In one embodiment, the first signaling comprises the first information block.

In one embodiment, the first information block is an RRC field in the first signaling.

In one embodiment, the first information block is an RRC IE in the first signaling.

In one embodiment, the first information block comprises at least one RRC field.

In one embodiment, the first information block comprises at least one RRC IE.

In one embodiment, the first information block comprises at least a first identifier and a first candidate configuration: the first identifier indicates the second serving cell.

In one embodiment, the first information block comprises at least one of a first identifier, a first candidate configuration, or a second condition subset: the first identifier indicates the second serving cell.

In one embodiment, the first identifier is a non-negative integer.

In one embodiment, the first identifier is a positive integer.

In one embodiment, the first identifier is a PCI of the second serving cell.

In one embodiment, the first identifier is a cell group identity of a cell group to which the second serving cell belongs.

In one embodiment, the first identifier is used to indicate the second serving cell.

In one embodiment, the first identifier is used to determine that the first candidate configuration is that of the second serving cell.

In one embodiment, an RRC IE or an RRC field in the first information block indicates the first identifier.

In one embodiment, an RRC IE or an RRC field in the first information block indicates the first candidate configuration.

In one embodiment, the first information block comprises one information block.

In one embodiment, the second information block comprises one information block.

In one embodiment, the third information block comprises one information block.

In one embodiment, at least one of the first information block, or the second information block, or the third information block belongs to a list.

In one embodiment, the above one information block belongs to a ConditionalReconfiguration IE.

In one embodiment, the above one information block is an RRC field or RRC IE in a CondalReconfiguration IE.

In one embodiment, the above one information block is an RRC field or RRC IE in a CondReconfigToAddModList IE.

In one embodiment, the above one information block is an RRC field in a field that includes condRRCReconfig in its name.

In one embodiment, the above one information block is not part of a ConditionalReconfiguration IE.

In one embodiment, the above one information block is an RRC IE, the RRC IE having at least one of SCG, or PSCell, or Selection, or candidate, or list in its name.

In one embodiment, the first signaling includes a first RRC IE, each information block in the first RRC IE having the same structure.

In one embodiment, any information block in the first RRC IE comprises at least one of an identification field, or a candidate configuration field, or a threshold field, or a departure threshold field, or an offset field.

In one embodiment, the first triggering condition is only for the second serving cell.

In one embodiment, the first triggering condition is for each cell in a first candidate cell subset.

In one embodiment, the first triggering condition is associated to 1 measurement identifier.

In one embodiment, the first triggering condition is associated to 2 measurement identifiers.

In one embodiment, the first triggering condition is associated to 1 or 2 measurement identifiers.

In one embodiment, the first triggering condition comprises 1 or 2 triggering events.

In one embodiment, the first triggering condition comprises 1 triggering event.

In one embodiment, the one measurement identifier is used to identify a measurement configuration.

In one embodiment, a triggering condition is a condition for a candidate configuration to be applied.

In one embodiment, a triggering condition is an execution condition to be satisfied to trigger the execution of a candidate configuration.

In one embodiment, the triggering condition refers to a triggering event.

In one embodiment, the triggering condition refers to an execution condition.

In one embodiment, the triggering condition refers to a CPC execution condition.

In one embodiment, the triggering condition refers to a CHO execution condition.

In one embodiment, the first triggering condition and the first candidate configuration are for the second serving cell.

In one embodiment, the phrase as a response to a first triggering condition being satisfied comprises: after the first triggering condition has been satisfied.

In one embodiment, the phrase as a response to a first triggering condition being satisfied comprises: when the first triggering condition is satisfied.

In one embodiment, the phrase as a response to a first triggering condition being satisfied comprises:

if the first triggering condition is satisfied.

In one embodiment, the action of disconnecting from a first serving cell comprises: leaving the first serving cell.

In one embodiment, the action of disconnecting from a first serving cell comprises: detaching from the first serving cell.

In one embodiment, the action of disconnecting from a first serving cell comprises: stopping transmitting on the first serving cell.

In one embodiment, the action of disconnecting from a first serving cell comprises: stopping receiving on the first serving cell.

In one embodiment, the action of disconnecting from a first serving cell comprises: releasing a connection to the first serving cell.

In one embodiment, the action of disconnecting from a first serving cell comprises: stopping use of wireless resources on the first serving cell.

In one embodiment, the action of disconnecting from a first serving cell comprises: stopping use of configuration information of the first serving cell.

In one embodiment, the first candidate configuration includes a physical cell identifier of the second serving cell.

In one embodiment, the first candidate configuration comprises a Broadcast Control Channel (BCCH) configuration of the second serving cell.

In one embodiment, the first candidate configuration includes a Master Information Block (MIB) of the second serving cell.

In one embodiment, the first candidate configuration comprises a value of an RRC field, the first signaling comprises the RRC field, and the RRC field includes newUE-Identity in its name, the value of the RRC field is a non-negative integer, and the value of the RRC field is used to indicate an identifier of the first node in a cell group to which the second serving cell belongs.

In one subembodiment, the value of the RRC field is configured via an RNTI-Value IE.

In one subembodiment, the value of the RRC field is not less than 0 and the value of the RRC field is not greater than 65535.

In one subembodiment, the action applying a first candidate configuration comprises: applying the value of one RRC field as a Cell Radio Network Temporary Identifier (C-RNTI) of the first node in a cell group to which the second serving cell belongs.

In one embodiment, the first candidate configuration comprises a lower layer configuration in an RRC field, the RRC field comprising a PCI of the second serving cell, the first signaling comprising the RRC field, the RRC field including spCellConfigCommon in its name.

In one subembodiment, the RRC field includes a ServingCellConfigCommon IE.

In one subembodiment, the RRC field includes a physCellId field, the physCellId field being set to the PCI of the second serving cell.

In one subembodiment, the RRC field comprises a downlinkConfigCommon field, the downlinkConfigCommon field comprising a downlink parameter of the second serving cell.

In one subembodiment, the RRC field comprises an uplinkConfigCommon field, the uplink ConfigCommon field comprising an uplink parameter of the second serving cell.

In one subembodiment, the action applying a first candidate configuration comprises: configuring lower layers according to the RRC field.

In one embodiment, the action applying a first candidate configuration comprises: starting synchronization to a downlink of the second serving cell.

In one embodiment, the action applying a first candidate configuration comprises: using the first candidate configuration.

In one embodiment, the action applying a first candidate configuration comprises: applying at least a portion of the first candidate configuration.

In one embodiment, the action applying a first candidate configuration comprises: executing a reconfiguration with sync.

In one embodiment, the action applying a first candidate configuration comprises: stopping a timer T310 in a cell group to which the first serving cell belongs if a Dual Active Protocol Stack (DAPS) bearer is not configured.

In one embodiment, the action applying a first candidate configuration comprises: stopping the timer T312 if timer T312 is running.

In one embodiment, the action applying a first candidate configuration comprises: starting the timer T304 if timer T304 is configured.

In one embodiment, the action applying a first candidate configuration comprises: starting timer T304.

In one embodiment, the first node is not configured with a DAPS Bearer.

In one embodiment, the first node is configured with a DAPS Bearer.

In one embodiment, the first serving cell is a CHO candidate cell.

In one embodiment, the first serving cell is a CPC candidate cell.

In one embodiment, the first serving cell is a candidate PCell.

In one embodiment, the first serving cell is a candidate PSCell.

In one embodiment, the first serving cell belongs to a candidate SCG.

In one embodiment, the first serving cell belongs to a candidate MCG.

In one embodiment, the second serving cell is a CHO candidate cell.

In one embodiment, the second serving cell is a CPC candidate cell.

In one embodiment, the second serving cell is a candidate PCell.

In one embodiment, the second serving cell is a candidate PSCell.

In one embodiment, the second serving cell belongs to a candidate MCG.

In one embodiment, within at least one slot before the first candidate configuration is applied, the first serving cell is a serving cell of the first node and the second serving cell is not a serving cell of the first node.

In one embodiment, within at least one slot after the first candidate configuration is applied, the first serving cell is not a serving cell of the first node and the second serving cell is a serving cell of the first node.

In one embodiment, within at least one slot before the first candidate configuration is applied, the second serving cell is not a serving cell of the first node.

In one embodiment, within at least one slot before the first candidate configuration is applied, the first serving cell is a serving cell of the first node.

In one embodiment, as a response to the first triggering condition being satisfied, it is determined that the second serving cell is a triggered cell.

In one embodiment, as a response to the first triggering condition being satisfied, it is determined that the second serving cell is a selected cell.

In one embodiment, the selected cell is one of the triggered cells.

In one embodiment, the second serving cell is the only triggered cell and the second serving cell is a selected cell.

In one embodiment, the second serving cell is one of multiple triggered cells, the second serving cell being a selected cell.

In one embodiment, as a response to the first triggering condition being satisfied, it is determined that the second serving cell is a triggered cell: if the second serving cell is the only triggered cell, the second serving cell is a selected cell: if the second serving cell is a triggered cell among multiple triggered cells, determining a cell among the multiple triggered cells as a selected cell, and the second serving cell is the selected cell.

In one subembodiment, the action of determining a cell among the multiple triggered cells comprises: selecting a cell among the multiple triggered cells.

In one subembodiment, the action of determining a cell among the multiple triggered cells comprises: selecting a cell among the multiple triggered cells based on UE implementation.

In one subembodiment, the action of determining a cell among the multiple triggered cells comprises: selecting a cell among the multiple triggered cells based on beams and beam quality.

In one subembodiment, the action of determining a cell among the multiple triggered cells comprises: selecting a cell among the multiple triggered cells based on whether a DAPS bearer is configured.

In one embodiment, before the action of disconnecting from a first serving cell and applying a first candidate configuration, it is determined that the second serving cell is a selected cell.

In one embodiment, the action “as a response to a first triggering condition being satisfied, disconnecting from a first serving cell and applying a first candidate configuration” comprises: in response to determining that the second serving cell is a selected cell, disconnecting from the first serving cell and applying the first candidate configuration.

In one embodiment, the phrase the first serving cell and the second serving cell each being a SpCell means: the first serving cell and the second serving cell are both of the type of SpCell.

In one embodiment, one of the first serving cell and the second serving cell is a serving cell and the other is a candidate cell.

In one embodiment, both of the first serving cell and the second serving cell are candidate cells.

In one embodiment, the SpCell is a PCell.

In one embodiment, the SpCell is a PSCell.

In one embodiment, the first candidate configuration includes a physical cell identifier of the second serving cell.

In one embodiment, the first candidate configuration includes Data Radio Bearer (DRB) configuration.

In one embodiment, the first candidate configuration includes Radio Link Control (RLC) configuration.

In one embodiment, the first candidate configuration includes Medium Access Control (MAC) configuration.

In one embodiment, the first candidate configuration is the configuration information of the second serving cell.

In one embodiment, the configuration information of the second serving cell comprises information of reconfiguration with sync.

In one embodiment, the configuration information of the second serving cell comprises an identifier of the first node in the second serving cell.

In one embodiment, the configuration information of the second serving cell comprises t304.

In one embodiment, the configuration information of the second serving cell comprises random access configuration.

In one embodiment, the configuration information of the second serving cell comprises smtc configuration.

In one embodiment, within a period of time after having received the first signaling and before determining that the first triggering condition is satisfied, the first node performing an evaluation for the first triggering condition is used to determine that the first triggering condition being satisfied occurs after reception of the first signaling.

In one embodiment, triggering events associated with any two triggering conditions of the multiple triggering conditions in the first condition set are the same.

In one embodiment, triggering events associated with any two triggering conditions of the multiple triggering conditions in the first condition set are different.

In one embodiment, the first triggering condition is an execution condition for applying the first candidate configuration: the first serving cell is a serving cell of the first node.

In one embodiment, the first triggering condition is an execution condition for applying configuration information of a candidate cell; the first serving cell is a serving cell of the first node.

In one embodiment, the first condition subset is associated to a first candidate cell set, and the second serving cell is a candidate cell in the first candidate cell set.

In one subembodiment, the first condition subset comprises only one triggering condition, the one triggering condition in the first condition subset corresponding to any candidate cell in the first candidate cell set.

In one subembodiment, the first condition subset comprises at least one triggering condition, each triggering condition in the first condition subset corresponding to a candidate cell in the first candidate cell set.

In one subembodiment, the first candidate cell set comprises at least the second serving cell.

In one subembodiment, the first candidate cell set comprises the third serving cell of this application.

In one subembodiment, the first candidate cell set does not include the third serving cell in this application.

In one embodiment, the first candidate cell set does not include the first serving cell if the first serving cell is a serving cell.

In one embodiment, the first condition subset comprises only one triggering condition.

In one embodiment, the first condition subset comprises at least one triggering condition.

In one embodiment, the phrase that the first triggering condition is a triggering condition in a first condition subset comprises that the first condition subset is the first triggering condition.

In one embodiment, the phrase that the first triggering condition is a triggering condition in a first condition subset comprises that the first condition subset comprises only one triggering condition, the first condition subset being the first triggering condition.

In one embodiment, the phrase that the first triggering condition is a triggering condition in a first condition subset comprises that the first condition subset comprises at least two triggering conditions, the first triggering condition being a triggering condition in the first condition subset.

In one embodiment, the phrase that the first triggering condition is a triggering condition in a first condition subset comprises that one triggering condition in the first condition subset is the first triggering condition.

In one embodiment, the phrase that the first triggering condition is a triggering condition in a first condition subset comprises that the first triggering condition belongs to the first condition subset.

In one embodiment, the phrase that the first condition subset is a proper subset of the first condition set comprises: the first condition set including each triggering condition in the first condition subset.

In one embodiment, the phrase that the first condition subset is a proper subset of the first condition set comprises: the first condition set including at least one triggering condition not belonging to the first condition subset.

In one embodiment, the phrase that the first condition subset is a proper subset of the first condition set comprises: the first condition set being different from the first condition subset.

In one embodiment, the phrase that the first condition subset is a proper subset of the first condition set comprises: a number of triggering conditions in the first condition subset being less than a number of triggering conditions in the first condition set.

In one embodiment, the phrase that the first condition subset is a proper subset of the first condition set comprises: the first condition set comprising at least two condition subsets, each of the at least two condition subsets comprising at least one triggering condition, the first condition subset being one condition subset of the at least two condition subsets.

In one embodiment, the first condition subset is related to the first serving cell, and any triggering condition other than the first condition subset in the first condition set is related to the first serving cell.

In one embodiment, the first condition subset is related to the first serving cell, and any triggering condition other than the first condition subset in the first condition set is unrelated to the first serving cell.

In one embodiment, the phrase that the first condition subset is related to the first serving cell comprises that the first condition subset is valid only if the first serving cell is a serving cell of the first node.

In one embodiment, the phrase that the first condition subset is related to the first serving cell comprises that triggering conditions in the first condition subset are evaluated only if the first serving cell is a serving cell of the first node.

In one embodiment, the phrase that the first condition subset is related to the first serving cell comprises that each candidate cell in the first candidate cell set is evaluated according to the first condition subset only if the first serving cell is a serving cell of the first node.

In one embodiment, each candidate cell in the first candidate cell set is evaluated according to the first condition subset and it is determined that the first triggering condition is satisfied.

In one embodiment, a cell being a serving cell of the first node means that the first node applies configuration information of the cell.

In one embodiment, a cell being a serving cell of the first node means that the first node uses wireless resources of the first cell.

In one embodiment, a cell being a serving cell of the first node means that the first node performs data transmission on the first cell.

In one embodiment, a cell being a serving cell of the first node means that the first node applies a measurement configuration of the first cell.

In one embodiment, a cell being a candidate cell means that the first node saves configuration information for the cell.

In one embodiment, a cell being a candidate cell means that an execution condition for applying the cell is evaluated.

In one embodiment, a cell being a candidate cell means that configuration information of the cell is not applied.

In one embodiment, a cell being a candidate cell means that no RRC connection is established between the cell and the first node.

In one embodiment, a cell being a candidate cell means that the first node is not using wireless resources of the cell.

In one embodiment, the first variable includes configuration information of a candidate cell.

In one embodiment, the first variable includes configuration information of a serving cell of the first node.

In one embodiment, the first variable includes configuration information of a candidate cell and configuration information of a serving cell of the first node.

In one embodiment, the first variable includes at least the former of the first information block, or the second information block, or the third information block.

In one embodiment, a cell identity of the first serving cell is used to determine the first candidate cell set.

In one embodiment, if the first serving cell is a candidate cell for the first node, the first candidate cell set includes a cell other than the first serving cell being associated to a SpCell in the first variable.

In one embodiment, the first signaling indicates the first candidate cell set.

In one embodiment, the first signaling indicates candidate cells in the first candidate cell set.

In one embodiment, the first signaling includes a cell identity of a candidate cell in the first candidate cell set.

In one embodiment, the first signaling includes an identifier of a candidate cell in the first candidate cell set.

In one embodiment, the first signaling includes a bitmap indicating a candidate cell in the first candidate cell set.

In one embodiment, the first candidate cell set is used to determine the first condition subset.

Typically, a cell identity of the first serving cell is used to determine the first condition subset from the first condition set.

### Embodiment 2

Embodiment 2 illustrates a schematic diagram of a network architecture according to one embodiment of the present application, as shown in FIG. 2. FIG. 2 illustrates a network architecture 200 of 5G New Radio (NR)/Long-Term Evolution (LTE)/Long-Term Evolution Advanced (LTE-A) systems. The 5G NR/LTE/LTE-A network architecture 200 may be called a 5G System/Evolved Packet System (5GS/EPS) 200 or other suitable terminology. The 5GS/EPS 200 may comprise UE(s) 201, a RAN 202, a 5G Core Network/Evolved Packet Core (5GC/EPC) 210, a Home Subscriber Server/Unified Data Management (HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services or other cellular networks. The RAN comprises a node 203 and another node 204 or another node 205. The node 203 provides UE 201 oriented user plane and control plane terminations. The node 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The node 203 provides an access point of the 5GC/EPC 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions.

Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The node 203 is connected to the 5GC/EPC 210 via an S1/ NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the node 203 can be connected to other node 204 via an Xn interface (like backhaul)/X2 interface.

In one embodiment, there exists an Xn interface (like backhaul)/X2 interface between the node 203 and the node 204.

In one embodiment, there doesn't exist an Xn interface (like backhaul)/X2 interface between the node 203 and the node 204.

In one embodiment, the node 204 can be connected to other node 205 via an Xn interface (like backhaul)/X2 interface.

In one embodiment, there exists an Xn interface (like backhaul)/X2 interface between the node 204 and the node 205.

In one embodiment, there doesn't exist an Xn interface (like backhaul)/X2 interface between the node 204 and the node 205.

In one embodiment, the node 203 can be connected to other node 205 via an Xn interface (like backhaul)/X2 interface.

In one embodiment, there exists an Xn interface (like backhaul)/X2 interface between the node 203 and the node 205.

In one embodiment, there doesn't exist an Xn interface (like backhaul)/X2 interface between the node 203 and the node 205.

In one embodiment, the UE 201 corresponds to the first node in the present application.

In one embodiment, the node 203 corresponds to the second node in the present application.

In one embodiment, the node 204 corresponds to the third node in the present application.

In one embodiment, the node 205 corresponds to the fourth node in the present application.

In one embodiment, the UE 201 corresponds to the first node in the present application: the gNB203 corresponds to the second node in the present application: the gNB204 corresponds to the third node in the present application; and the node 205 corresponds to the fourth node in the present application.

In one embodiment, the UE 201 is a UE.

In one embodiment, the UE 201 is a BaseStation (BS).

In one embodiment, the node 203 is a base station.

In one embodiment, the node 203 is a UE.

In one embodiment, the node 203 is a relay.

In one embodiment, the node 203 is a Gateway.

In one embodiment, the node 204 is a base station.

In one embodiment, the node 204 is a UE.

In one embodiment, the node 204 is a relay.

In one embodiment, the node 204 is a Gateway.

In one embodiment, the node 205 is a base station.

In one embodiment, the node 205 is a UE.

In one embodiment, the node 205 is a relay.

In one embodiment, the node 205 is a Gateway:

In one embodiment, the UE supports transmissions in Non-Terrestrial Network (NTN).

In one embodiment, the UE supports transmissions in Terrestrial Network (TN).

In one embodiment, the UE supports transmissions in large-delay-difference networks.

In one embodiment, the UE supports Dual Connection (DC) transmissions.

In one embodiment, the UE includes a mobile terminal, or the UE includes an aircraft, or the UE includes a vehicle-mounted terminal, or the UE includes a vessel, or the UE includes an IoT terminal, or the UE includes an IIOT terminal, or the UE includes a device supporting low-delay and high-reliability transmission, or the UE includes testing equipment, or the UE includes a signaling test instrument.

In one embodiment, the base station is a BS, or the base station is a Base Transceiver Station (BTS), or the base station is a NodeB (NB), or the base station is a gNB, or the base station is an eNB, or the base station is an ng-eNB, or the base station is an en-gNB.

In one embodiment, the base station includes test equipment, or the base station includes a signaling test instrument, or the base station includes satellite equipment, or the base station includes a flight platform, or the base station includes a Macro Cellular base station, or the base station includes a Micro Cell base station, or the base station includes a Pico Cell base station, or the base station includes a Femtocell.

In one embodiment, the base station supports transmissions in NTN.

In one embodiment, the base station supports transmissions in large-delay-difference networks.

In one embodiment, the base station supports transmissions in TN.

In one embodiment, the base station comprises a base station device supporting large time-delay difference.

In one embodiment, the base station comprises a Transmitter Receiver Point (TRP).

In one embodiment, the base station comprises a Centralized Unit (CU).

In one embodiment, the base station comprises a Distributed Unit (DU).

In one embodiment, the base station comprises an Integrated Access and Backhaul-node (IAB-node).

In one embodiment, the base station comprises an IAB-donor.

In one embodiment, the base station comprises an IAB-donor-CU.

In one embodiment, the base station comprises an IAB-donor-DU.

In one embodiment, the base station comprises an IAB-DU.

In one embodiment, the base station comprises an IAB-MT.

In one embodiment, the relay comprises a L3 relay.

In one embodiment, the relay comprises a L2 relay:

In one embodiment, the relay comprises a Router.

In one embodiment, the relay comprises an Exchanger.

In one embodiment, the relay comprises a UE.

In one embodiment, the relay comprises a base station.

In one embodiment, the second node is a MN, the third node is a SN, and the fourth node is a SN.

In one embodiment, the second node is a MN, the third node is a target SN, and the fourth node is another target SN.

In one embodiment, the second node is a source MN, the third node is a target MN, and the fourth node is another target MN.

In one embodiment, the second node is a source SN, the third node is a target MN, and the fourth node is another target MN.

### Embodiment 3

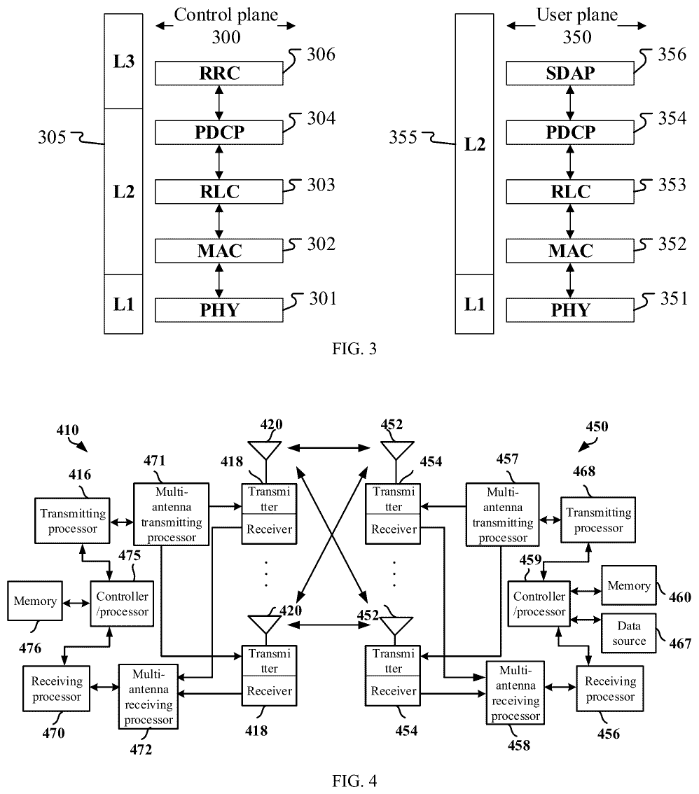

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 is represented by three layers, which are layer1, layer2 and layer3.

The layer 1 (L1) is the lowest layer which performs signal processing functions of various PHY layers. The L1 is called PHY 301 in the present application. The layer 2 (L2) 305 is above the PHY 301, and is in charge of the link between the UE and the gNB via the PHY 301. The L2 305 comprises a Medium Access Control (MAC) sublayer 302, a Radio Link Control (RLC) sublayer 303 and a Packet Data Convergence Protocol (PDCP) sublayer 304. The PDCP sublayer 304 provides multiplexing among variable radio bearers and logical channels.

The PDCP sublayer 304 provides security by encrypting a packet and provides support for inter-cell handover. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling. The radio protocol architecture in the user plane 350 comprises the L1 layer and the L2 layer. In the user plane 350, the radio protocol architecture used for a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics.

In one embodiment, the radio protocol architecture in FIG. 3 is applicable to the first node in the present application.

In one embodiment, the radio protocol architecture in FIG. 3 is applicable to the second node in the present application.

In one embodiment, the radio protocol architecture in FIG. 3 is applicable to the third node in the present application.

In one embodiment, the radio protocol architecture in FIG. 3 is applicable to the fourth node in the present application.

In one embodiment, the first signaling in the present application is generated by the RRC 306.

In one embodiment, the first signaling in the present application is generated by the MAC302 or the MAC352.

In one embodiment, the second signaling in the present application is generated by the RRC306.

In one embodiment, the second signaling in the present application is generated by the MAC302 or the MAC352.

In one embodiment, the third signaling in the present application is generated by the RRC306.

In one embodiment, the third signaling in the present application is generated by the MAC302 or the MAC352.

In one embodiment, the fourth signaling in the present application is generated by the RRC 306.

In one embodiment, the fourth signaling in the present application is generated by the MAC302 or the MAC352.

### Embodiment 4

Embodiment 4 illustrates a schematic diagram of a first communication device and a second communication device according to the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network is provided to the controller/processor 475. The controller/processor 475 provides functions of the L2 layer. In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also in charge of a retransmission of a lost packet and a signaling to the first communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 410 side and the mapping of signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any first communication device 450-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with the memory 460 that stores program code and data: the memory 460 may be called a computer readable medium. In the transmission from the second communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication node 410 to the first communication node 450, the controller/processor 459 performs header compression, encryption, packet segmentation and reordering, and multiplexing between a logical channel and a transport channel based on radio resource allocation so as to provide the L2 layer functions used for the user plane and the control plane. The controller/processor 459 is also responsible for a retransmission of a lost packet, and a signaling to the second communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data: the memory 476 may be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device (UE) 450. The higher-layer packet coming from the controller/processor 475 may be provided to the core network.

In one embodiment, the first communication device 450 comprises at least one processor and at least one memory: The at least one memory comprises computer program codes: the at least one memory and the computer program codes are configured to be used in collaboration with the at least one processor. The first communication device 450 at least receives a first signaling, the first signaling being used to indicate a first condition set, the first condition set including multiple triggering conditions: as a response to a first triggering condition being satisfied, disconnects from a first serving cell and applies a first candidate configuration, the first candidate configuration including configuration information for the second serving cell, the first serving cell and the second serving cell each being a SpCell: herein, the first triggering condition being satisfied occurs after receiving the first signaling, the first triggering condition is a triggering condition in a first condition subset, and the first condition subset is a proper subset of the first condition set: the first condition subset is related to the first serving cell.

In one embodiment, the first communication device 450 comprises a memory that stores a computer readable instruction program. The computer readable instruction program generates actions when executed by at least one processor. The actions include: receiving a first signaling, the first signaling being used to indicate a first condition set, the first condition set including multiple triggering conditions: as a response to a first triggering condition being satisfied, disconnecting from a first serving cell and applying a first candidate configuration, the first candidate configuration including configuration information for the second serving cell, the first serving cell and the second serving cell each being a SpCell: herein, the first triggering condition being satisfied occurs after receiving the first signaling, the first triggering condition is a triggering condition in a first condition subset, and the first condition subset is a proper subset of the first condition set: the first condition subset is related to the first serving cell.

In one embodiment, the second communication device 410 comprises at least one processor and at least one memory: The at least one memory comprises computer program codes: the at least one memory and the computer program codes are configured to be used in collaboration with the at least one processor. The second communication device 410 at least transmits a first signaling, the first signaling being used to indicate a first condition set, the first condition set including multiple triggering conditions: herein, as a response to a first triggering condition being satisfied, a first serving cell is disconnected and a first candidate configuration is applied, the first candidate configuration including configuration information for the second serving cell, the first serving cell and the second serving cell each being a SpCell: the first triggering condition being satisfied occurs after receiving the first signaling, the first triggering condition is a triggering condition in a first condition subset, and the first condition subset is a proper subset of the first condition set: the first condition subset is related to the first serving cell: the second communication device 410 corresponds to the second node in the present application.

In one embodiment, the second communication device 410 comprises a memory that stores a computer readable instruction program. The computer readable instruction program generates actions when executed by at least one processor. The actions include: transmitting a first signaling, the first signaling being used to indicate a first condition set, the first condition set including multiple triggering conditions: herein, as a response to a first triggering condition being satisfied, a first serving cell is disconnected and a first candidate configuration is applied, the first candidate configuration including configuration information for the second serving cell, the first serving cell and the second serving cell each being a SpCell: the first triggering condition being satisfied occurs after receiving the first signaling, the first triggering condition is a triggering condition in a first condition subset, and the first condition subset is a proper subset of the first condition set: the first condition subset is related to the first serving cell: the second communication device 410 corresponds to the second node in the present application.

In one embodiment, the second communication device 410 comprises at least one processor and at least one memory. The at least one memory comprises computer program codes: the at least one memory and the computer program codes are configured to be used in collaboration with the at least one processor. The second communication device 410 at least has a receiver of a first signaling synchronizing to a second serving cell as a response to a first triggering condition being satisfied: herein, the first signaling is used to indicate a first condition set, the first condition set including multiple triggering conditions: as a response to a first triggering condition being satisfied, a first serving cell is disconnected and a first candidate configuration is applied, the first candidate configuration including configuration information for the second serving cell, the first serving cell and the second serving cell each being a SpCell: the first triggering condition being satisfied occurs after receiving the first signaling, the first triggering condition is a triggering condition in a first condition subset, and the first condition subset is a proper subset of the first condition set: the first condition subset is related to the first serving cell: the second communication device 410 corresponds to the third node in the present application.

In one embodiment, the second communication device 410 comprises a memory that stores a computer readable instruction program. The computer readable instruction program generates actions when executed by at least one processor. The actions include: having a receiver of a first signaling synchronizing to a second serving cell as a response to a first triggering condition being satisfied: herein, the first signaling is used to indicate a first condition set, the first condition set including multiple triggering conditions: as a response to a first triggering condition being satisfied, a first serving cell is disconnected and a first candidate configuration is applied, the first candidate configuration including configuration information for the second serving cell, the first serving cell and the second serving cell each being a SpCell: the first triggering condition being satisfied occurs after receiving the first signaling, the first triggering condition is a triggering condition in a first condition subset, and the first condition subset is a proper subset of the first condition set; the first condition subset is related to the first serving cell; the second communication device 410 corresponds to the third node in the present application.

In one embodiment, the antenna 452, the receiver 454, the receiving processor 456 and the controller/processor 459 are used for receiving a first signaling: at least one of the antenna 420, the transmitter 418, the transmitting processor 416 or the controller/processor 475 is used for transmitting a first signaling.

In one embodiment, the antenna 452, the receiver 454, the receiving processor 456, and the controller/processor 459 are used for receiving a second signaling: at least one of the antenna 420, the transmitter 418, the transmitting processor 416 or the controller/processor 475 is used for transmitting a second signaling.

In one embodiment, the antenna 452, the transmitter 454, the transmitting processor 468 and the controller/processor 459 are used for transmitting a third signaling: at least one of the antenna 420, the receiver 418, the receiving processor 470 or the controller/processor 475 is used for receiving a third signaling.

In one embodiment, the antenna 452, the transmitter 454, the transmitting processor 468 and the controller/processor 459 are used for transmitting a fourth signaling: at least one of the antenna 420, the receiver 418, the receiving processor 470 or the controller/processor 475 is used for receiving a fourth signaling.

In one embodiment, the first communication device 450 corresponds to the first node in the present application.

In one embodiment, the second communication device 410 corresponds to the second node in the present application.

In one embodiment, the second communication device 410 corresponds to the third node in the present application.

In one embodiment, the second communication device 410 corresponds to the fourth node in the present application.

In one embodiment, the first communication device 450 is a UE.

In one embodiment, the first communication device 450 is a UE supporting large delay difference.

In one embodiment, the first communication device 450 is a UE supporting NTN.

In one embodiment, the first communication device 450 is an aircraft.

In one embodiment, the first communication device 450 is capable of positioning.

In one embodiment, the first communication device 450 is incapable of positioning.

In one embodiment, the first communication device 450 is a UE supporting TN.

In one embodiment, the second communication device 410 is a base station (gNB/eNB/ng-eNB).

In one embodiment, the second communication device 410 is a base station supporting large delay difference.

In one embodiment, the second communication device 410 is a base station supporting NTN.

In one embodiment, the second communication device 410 is satellite equipment.

In one embodiment, the second communication device 410 is a flight platform.

In one embodiment, the second communication device 410 is a base station supporting TN.

### Embodiment 5

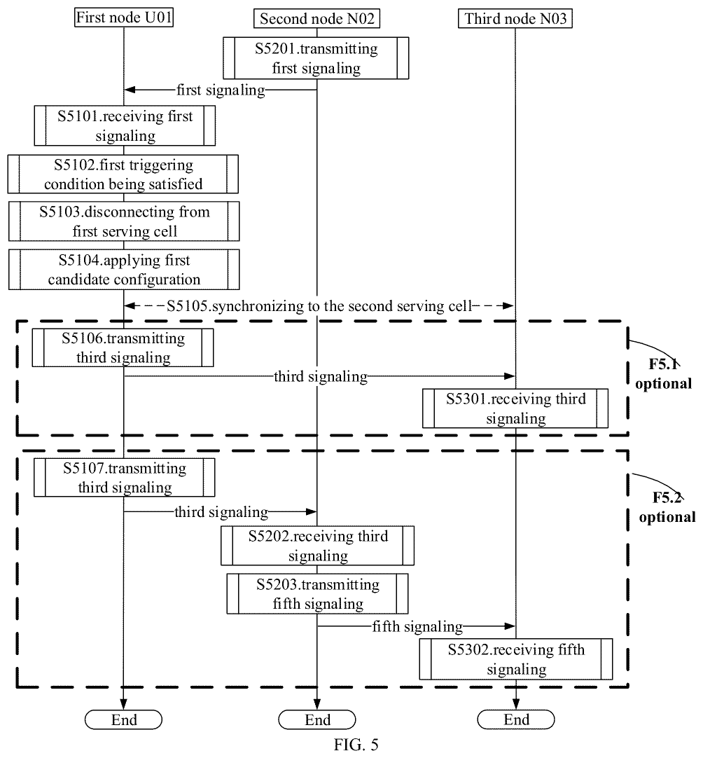

Embodiment 5 illustrates a flowchart of radio signal transmission according to one embodiment of the present application, as shown in FIG. 5. It should be particularly noted that the sequence illustrated herein does not set any limit to the signal transmission order or implementation order in the present application.

The first node U01 receives a first signaling in step S5101, the first signaling being used to indicate a first condition set, the first condition set including multiple triggering conditions: determines in step S5102 that a first triggering condition is satisfied; and in step S5103, disconnects from the first serving cell as a response to the first triggering condition being satisfied: in step S5104, applies a first candidate configuration as a response to the first triggering condition being satisfied: in step S5105, synchronizes to the second serving cell as a response to the first triggering condition being satisfied: in step S5106, transmits a third signaling; and in step S5107, transmits the third signaling.

The second node N02 transmits the first signaling in step S5201: receives the third signaling in step S5202; and transmits the fifth signaling in step S5203.

The third node N03 receives the third signaling in step S5301; and receives the fifth signaling in step S5302.

In Embodiment 5, the first candidate configuration includes configuration information for a second serving cell, the first serving cell and the second serving cell each being a SpCell: the first triggering condition being satisfied occurs after receiving the first signaling, the first triggering condition is a triggering condition in a first condition subset, and the first condition subset is a proper subset of the first condition set: the first condition subset is related to the first serving cell: the third signaling comprises information being used to confirm successful access to the second serving cell.

In one embodiment, the second node N02 is a MN.

In one embodiment, the third node N03 is a target SN.

In one embodiment, the second node N02 is a source MN and the third node N03 is a target MN.

In one embodiment, the second node N02 is a MN and the third node N03 is a target SN.

In one embodiment, the second node N02 is a source SN and the third node N03 is a target SN.

In one embodiment, the third node N03 is a maintenance base station for the second serving cell.

In one embodiment, the second node N02 is a maintenance base station for the first serving cell.

In one embodiment, the second node N02 is not a maintenance base station for the first serving cell.

In one embodiment, the action applying a first candidate configuration comprises the action of synchronizing to the second serving cell.

In one embodiment, the action applying a first candidate configuration does not comprise the action of synchronizing to the second serving cell.

In one embodiment, if the first condition set is for a PCell, the action of synchronizing to the second serving cell is prior to the action of transmitting a third signaling.

In one embodiment, if the first condition set is for a PSCell, the action of synchronizing to the second serving cell is prior to the action of transmitting a third signaling.

In one embodiment, if the first condition set is for a PSCell, the order of the action of synchronizing to the second serving cell and the action of transmitting a third signaling is determined based on the UE implementation.

In one embodiment, the action of synchronizing to the second serving cell is optional.

In one embodiment, the action of synchronizing to the second serving cell is indicated.

In one embodiment, the action of synchronizing to the second serving cell comprises: performing a random access procedure on the second serving cell.

In one embodiment, the action of synchronizing to the second serving cell comprises: transmitting a random access preamble on the second serving cell and as a response to the random access preamble being sent, receiving a MAC Random Access Response (RAR).

In one embodiment, the action of synchronizing to the second serving cell comprises: transmitting a random access preamble on the second serving cell: receiving a MAC RAR as a response to the random access preamble being sent: transmitting a message 3 as a response to the MAC RAR being received, the message 3 comprising a C-RNTI MAC Control Element (CE), the C-RNTI MAC CE comprising a C-RNTI of the first node U01 in the second serving cell; and receiving a message 4 as a response to the message 3 being sent, the message 4 being associated to the C-RNTI.

In one embodiment, the action of synchronizing to the second serving cell comprises: transmitting a message A on the second serving cell, the message A comprising a random access preamble and at least a C-RNTI MAC CE; and as a response to the random access preamble being sent, receiving a fallbackRAR: as a response to the fallbackRAR being received, transmitting a message 3, the message 3 comprising at least a C-RNTI MAC CE, the C-RNTI MAC CE comprising a C-RNTI of the first node U01 in the second serving cell; and receiving a message 4 as a response to the message 3 being sent, the message 4 being associated with the C-RNTI.

In one embodiment, the action of synchronizing to the second serving cell comprises: transmitting a message A on the second serving cell, the message A comprising a random access preamble and at least a C-RNTI MAC CE, the C-RNTI MAC CE comprising a C-RNTI of the first node U01 in the second serving cell; and receiving a successRAR as a response to the random access preamble being sent.

In one embodiment, the third signaling includes at least a RRCReconfigurationComplete message.

In one embodiment, the third signaling includes at least a RRCConnectionReconfigurationComplete message.

In one embodiment, the third signaling is a ULInformation TransferMRDC message and the third signaling includes a RRCReconfigurationComplete message.

In one embodiment, the third signaling is a ULInformationTransferMRDC message and the third signaling includes a RRCConnectionReconfigurationComplete message.

In one embodiment, the third signaling is a RRCReconfigurationComplete message.

In one embodiment, the third signaling is a RRCConnectionReconfigurationComplete message.

In one embodiment, the information confirming successful access to the second serving cell is a RRCReconfigurationComplete message.

In one embodiment, the information confirming successful access to the second serving cell is a RRCConnectionReconfigurationComplete message.

In one embodiment, the dashed-line box F5.1 is optional.

In one embodiment, the dashed-line box F5.2 is optional.

In one embodiment, one of the dashed-line box F5.1 or the dashed-line box F5.2 exists.

In one embodiment, the dashed-line box F5.1 exists and the dashed-line box F5.2 does not exist.

In one embodiment, a receiver of the third signaling is a maintenance base station of the second serving cell.

In one embodiment, a receiver of the third signaling is a maintenance base station of a PCell.

In one embodiment, a receiver of the third signaling is the third node N03, the third node N03 being a target SN.

In one embodiment, a receiver of the third signaling is the second node N02, the second node N02 being a MN.

In one embodiment, the SRB for the third signaling is SRB1.

In one embodiment, the SRB for the third signaling is SRB3 or split SRB1.

In one embodiment, the third signaling is a RRCReconfigurationComplete message.

In one embodiment, the third signaling is a RRCConnectionReconfigurationComplete message.

In one embodiment, the dashed-line box F5.1 does not exist and the dashed-line box F5.2 exists.

In one embodiment, the third signaling is used to trigger the fifth signaling, the fifth signaling comprising at least a portion of the third signaling, a receiver of the fifth signaling being a maintenance base station of the second serving cell.

In one embodiment, a Signaling Radio Bearer (SRB) for the third signaling is SRB1.

In one embodiment, the third signaling is a ULInformationTransferMRDC message and the third signaling includes a RRCReconfigurationComplete message.

In one embodiment, the third signaling is a ULInformation TransferMRDC message and the third signaling includes a RRCConnectionReconfigurationComplete message.

In one embodiment, the fifth signaling is transmitted via an Xn interface.

In one embodiment, the fifth signaling is transmitted via an X2 interface.

In one embodiment, the fifth signaling comprises a CG-Config message.

In one embodiment, the fifth signaling comprises a CG-ConfigInfo message.

In one embodiment, the fifth signaling comprises at least a RRCReconfigurationComplete message in the third signaling.

In one embodiment, the fifth signaling comprises at least a RRCConnectionReconfigurationComplete message in the third signaling.

In one embodiment, the step S5105 precedes the step S5106.

In one embodiment, the step S5105 is after the step S5106.

In one embodiment, the step S5105 is performed.

In one embodiment, the step S5105 is not performed.

### Embodiment 6

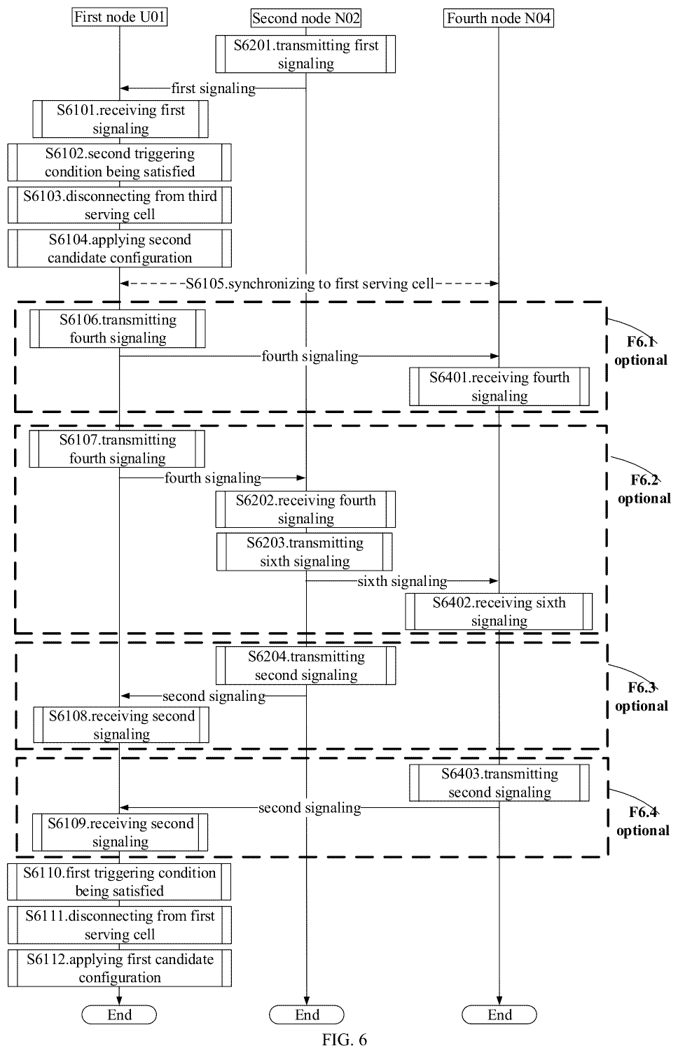

Embodiment 6 illustrates a flowchart of signal transmission according to another embodiment of the present application, as shown in FIG. 6. It should be particularly noted that the sequence illustrated herein does not set any limit to the signal transmission order or implementation order in the present application.

The first node U01 receives a first signaling in step S6101, the first signaling being used to indicate a first condition set, the first condition set including multiple triggering conditions: determines in step S6102 that a second triggering condition is satisfied; and in step S6103, disconnects from the third serving cell as a response to the second triggering condition being satisfied: in step S6104, applies a second candidate configuration as a response to the second triggering condition being satisfied: in step S6105, synchronizes to the first serving cell as a response to the second triggering condition being satisfied: in step S6106, transmits a fourth signaling; and in step S6107, transmits the fourth signaling: receives a second signaling in step S6108: receives the second signaling in step S6109; and determines in step S6110 that the first triggering condition is satisfied: in step S6111, as a response to the first triggering condition being satisfied, disconnects from the first serving cell; and in step S6112, as a response to the first triggering condition being satisfied, applies a first candidate configuration:

The second node N02 transmits the first signaling in step S6201: receives the fourth signaling in step S6202: transmits the sixth signaling in step S6203; and transmits the second signaling in step S6204.

The fourth node N04 receives the fourth signaling in step S6401: receives the sixth signaling in step S6402; and transmits the second signaling in step S6403.

In Embodiment 6, the second candidate configuration includes configuration information for the first serving cell, the third serving cell being a SpCell: the action of receiving the first signaling occurs before the second triggering condition being satisfied: the fourth signaling includes information that is used to confirm successful access to the first serving cell: the second signaling is used to indicate the first condition set: the first candidate configuration includes configuration information for a second serving cell, the first serving cell and the second serving cell each being a SpCell: the first triggering condition being satisfied occurs after receiving the first signaling, the first triggering condition is a triggering condition in a first condition subset, and the first condition subset is a proper subset of the first condition set: the first condition subset is related to the first serving cell.

Typically, the first signaling explicitly indicates the first condition set.

Typically, the first signaling is used to indicate the second candidate configuration.

In one embodiment, the fourth node N04 is a maintenance base station for the first serving cell.

In one embodiment, the third serving cell is a serving cell of the first node U01 before the action of applying the second candidate configuration.

In one embodiment, the first serving cell is a candidate cell before the action of applying the second candidate configuration.

In one embodiment, the first serving cell is not a serving cell of the first node U01 before the action of applying the second candidate configuration.

In one embodiment, the first signaling indicates the second triggering condition.

In one embodiment, the first signaling indicates the third condition subset.

In one embodiment, the first signaling indicates the third condition subset, and the second signaling indicates the first condition subset.

In one embodiment, the first signaling indicates the third condition subset and the first condition subset.

In one embodiment, the second triggering condition is a triggering condition in a third condition subset, and the third condition subset is a proper subset of the first condition set: the third condition subset is related to the third serving cell.

In one embodiment, the second triggering condition is associated to the first serving cell.

In one embodiment, the third condition subset is associated to a second candidate cell set, and the third serving cell is a candidate cell in the second candidate cell set.

In one embodiment, the second candidate cell set does not include the third serving cell if the third serving cell is a serving cell.

In one embodiment, a cell identity of the third serving cell is used to determine the second candidate cell set.

In one embodiment, if the third serving cell is a candidate cell for the first node U01, the second candidate cell set includes a cell other than the third serving cell being associated to a SpCell in the first variable.

In one embodiment, the first signaling indicates the second candidate cell set.

In one embodiment, the first signaling indicates candidate cells in the second candidate cell set.

In one embodiment, the first signaling includes a cell identity of a candidate cell in the second candidate cell set.

In one embodiment, the first signaling includes an identifier of a candidate cell in the second candidate cell set.

In one embodiment, the first signaling includes a bitmap indicating a candidate cell in the second candidate cell set.

In one embodiment, the second candidate cell set is used to determine the third condition subset.

In one embodiment, the second signaling is used to determine the first candidate cell set.

In one embodiment, the second signaling indicates candidate cells in the first candidate cell set.

In one embodiment, the second signaling includes a cell identity of a candidate cell in the first candidate cell set.

In one embodiment, the second signaling includes an identifier of a candidate cell in the first candidate cell set.

In one embodiment, the second signaling includes a bitmap indicating a candidate cell in the first candidate cell set.

In one subembodiment, one bit in the bitmap corresponds to one cell.

In one subembodiment, if one bit in the bitmap is set to 1, the one bit corresponds to a cell that is a candidate cell in the first candidate cell set.

In one subembodiment, if one bit in the bitmap is set to 0, the one bit corresponds to a cell that is not a candidate cell in the first candidate cell set.

In one embodiment, the first candidate cell set is smaller than the number of cells in the first variable.

In one embodiment, the first candidate cell set is not greater than the number of cells in the first variable.

In one embodiment, the first variable includes each candidate cell in the first candidate cell set.

In one embodiment, the second candidate configuration comprises configuration information in a Reconfiguration WithSync field, the Reconfiguration WithSync field comprising the PCI of the first serving cell.

In one embodiment, the second candidate configuration comprises a Physical Cell Identifier (PCI) of the first serving cell.

In one embodiment, the second candidate configuration comprises a BCCH configuration of the first serving cell.

In one embodiment, the second candidate configuration comprises a MIB of the first serving cell.

In one embodiment, the second candidate configuration comprises a value of an RRC field, a name of the RRC field including newUE-Identity, and the value of the RRC field being used to indicate an identifier of the first node U01 in a cell group to which the first serving cell belongs.

In one embodiment, the second candidate configuration comprises a lower layer configuration in an RRC field, the RRC field comprising a PCI of the first serving cell, the first signaling comprising the RRC field, the RRC field including spCellConfigCommon in its name.

In one embodiment, as a response to the action of receiving the first signaling, the second triggering condition is evaluated.

In one embodiment, as a response to the action of receiving the first signaling, each triggering condition in the third condition subset is evaluated.

In one embodiment, that the second triggering condition is satisfied is determined by the action of evaluating the second triggering condition.

In one embodiment, the second signaling is received.

In one embodiment, the second signaling is not received.

In one embodiment, the second signaling exists.

In one embodiment, the second signaling does not exist.

In one embodiment, the second signaling is an RRC message

In one embodiment, the second signaling comprises an RRC message.

In one embodiment, the second signaling comprises multiple RRC messages.

In one embodiment, the second signaling is used to determine that the first condition subset is in effect.

In one embodiment, the second signaling is used to determine the first condition subset.

In one embodiment, the second signaling includes the first threshold.

In one embodiment, the second signaling is used to update the first condition set.

In one embodiment, the second signaling indicates the first triggering condition.

In one embodiment, the second signaling indicates the first condition subset.

Typically, the second signaling is optional, i.e. when the second signaling is not sent, the configuration of the first condition set occurs before the second triggering condition is satisfied.

In one embodiment, when the second signaling is not transmitted, the first signaling is used to indicate the first candidate configuration.

In one embodiment, the second signaling is used to indicate the first candidate configuration.

In one embodiment, the first signaling indicates a first condition pool, and the second signaling indicates the first condition set from the first condition pool, the first condition set being a proper subset of the first condition pool.

In one embodiment, the first signaling is used to indicate a first set of conditions to be updated, and

the second signaling modifies the first set of conditions to be updated to the first condition set.

Typically, the second signaling removes at least one triggering condition from the first set of conditions to be updated.

Typically, the second signaling adds at least one triggering condition to the first set of conditions to be updated.

In one embodiment, the at least one triggering condition added by the second signaling is the first condition subset.

In one embodiment, the first signaling is an RRC signaling and the second signaling is signaling at a protocol layer below the RRC layer.

In one embodiment, the second signaling comprises one MAC CE.

In one embodiment, the action applying a second candidate configuration comprises the action of synchronizing to the first serving cell.

In one embodiment, the action applying a second candidate configuration does not comprise the action of synchronizing to the first serving cell.

In one embodiment, if the first condition set is for a PCell, the action of synchronizing to the first serving cell is prior to the action of transmitting a fourth signaling.

In one embodiment, if the first condition set is for a PSCell, the action of synchronizing to the first serving cell is prior to the action of transmitting a fourth signaling.

In one embodiment, if the first condition set is for a PSCell, the order of the action of synchronizing to the first serving cell and the action of transmitting a fourth signaling is determined based on the UE implementation.

In one embodiment, the action of synchronizing to the first serving cell is optional.

In one embodiment, the action of synchronizing to the first serving cell is indicated.

In one embodiment, the action of synchronizing to the first serving cell comprises: performing a random access procedure on the first serving cell.

In one embodiment, the action of synchronizing to the first serving cell comprises: transmitting a random access preamble on the first serving cell and as a response to the random access preamble being sent, receiving a MAC RAR.

In one embodiment, the action of synchronizing to the first serving cell comprises: transmitting a random access preamble on the first serving cell: receiving a MAC RAR as a response to the random access preamble being sent: transmitting a message 3 as a response to the MAC RAR being received, the message 3 comprising a C-RNTI MAC CE, the C-RNTI MAC CE comprising a C-RNTI of the first node U01 in the first serving cell; and receiving a message 4 as a response to the message 3 being sent, the message 4 being associated to the C-RNTI.

In one embodiment, the action of synchronizing to the first serving cell comprises: transmitting a message A on the first serving cell, the message A comprising a random access preamble and at least a C-RNTI MAC CE; and as a response to the random access preamble being sent, receiving a fallbackRAR: as a response to the fallbackRAR being received, transmitting a message 3, the message 3 comprising at least a C-RNTI MAC CE, the C-RNTI MAC CE comprising a C-RNTI of the first node U01 in the first serving cell; and receiving a message 4 as a response to the message 3 being sent, the message 4 being associated with the C-RNTI.

In one embodiment, the action of synchronizing to the first serving cell comprises: transmitting a message A on the first serving cell, the message A comprising a random access preamble and at least a C-RNTI MAC CE, the C-RNTI MAC CE comprising a C-RNTI of the first node U01 in the first serving cell; and receiving a successRAR as a response to the random access preamble being sent.

In one embodiment, a receiver of the fourth signaling is a maintenance base station of the first serving cell.

In one embodiment, a receiver of the fourth signaling is a maintenance base station of a PCell.

In one embodiment, a receiver of the fourth signaling is the fourth node N04.

In one embodiment, a receiver of the fourth signaling is the second node N02.

In one embodiment, the second node N02 is a source MN and the fourth node N04 is a target MN.

In one embodiment, the second node N02 is a source SN and the fourth node N04 is a target SN.

In one embodiment, the second node N02 is a MN and the fourth node N04 is a target SN.

In one embodiment, the fourth signaling includes at least a RRCReconfigurationComplete message.

In one embodiment, the fourth signaling includes at least a RRCConnectionReconfigurationComplete message.

In one embodiment, the fourth signaling is a ULInformationTransferMRDC message and the fourth signaling includes a RRCReconfigurationComplete message.

In one embodiment, the fourth signaling is a ULInformationTransferMRDC message and the fourth signaling includes a RRCConnectionReconfigurationComplete message.

In one embodiment, the fourth signaling is a RRCReconfigurationComplete message.

In one embodiment, the fourth signaling is a RRCConnectionReconfigurationComplete message.

In one embodiment, the dashed-line box F6.1 is optional.

In one embodiment, the dashed-line box F6.2 is optional.

In one embodiment, one of the dashed-line box F6.1 or the dashed-line box F6.2 exists.

In one embodiment, the dashed-line box F6.1 exists and the dashed-line box F6.2 does not exist.

In one subembodiment, a receiver of the fourth signaling is the second node N02.

In one subembodiment, the SRB for the fourth signaling is SRB3.

In one subembodiment, the SRB for the fourth signaling is split SRB1.

In one subembodiment, the fourth signaling is a RRCReconfigurationComplete message.

In one subembodiment, the fourth signaling is a RRCConnectionReconfigurationComplete message.

In one embodiment, the dashed-line box F6.1 does not exist and the dashed-line box F6.2 exists.

In one subembodiment, the fourth signaling is used to trigger a sixth signaling, the sixth signaling comprising at least a portion of the fourth signaling, a receiver of the sixth signaling being a maintenance base station of the first serving cell.

In one subembodiment, a receiver of the fourth signaling is the second node N02.

In one subembodiment, the SRB for the fourth signaling is SRB1.

In one subembodiment, the fourth signaling is a ULInformation TransferMRDC message, and the fourth signaling includes a RRCReconfigurationComplete message.

In one subembodiment, the fourth signaling is a ULInformationTransferMRDC message, and the fourth signaling includes a RRCConnectionReconfigurationComplete message.

In one subembodiment, the sixth signaling is transmitted via an Xn interface.

In one subembodiment, the sixth signaling is transmitted via an X2 interface.

In one subembodiment, the sixth signaling comprises a CG-Config message.

In one subembodiment, the sixth signaling comprises a CG-ConfigInfo message.

In one subembodiment, the sixth signaling comprises at least a RRCReconfigurationComplete message in the fourth signaling.

In one subembodiment, the sixth signaling comprises at least a RRCConnectionReconfigurationComplete in the fourth signaling.

In one embodiment, the dashed-line box F6.3 is optional.

In one embodiment, the dashed-line box F6.4 is optional.

In one embodiment, the dashed-line box F6.3 is present.

In one embodiment, the dashed-line box F6.3 does not exist.

In one embodiment, the dashed-line box F6.4 is present.

In one embodiment, the dashed-line box F6.4 does not exist.

In one embodiment, the step S6105 precedes the step S6106.

In one embodiment, the step S6105 is after the step S6106.

In one embodiment, the step S6105 is performed.

In one embodiment, the step S6105 is not performed.

### Embodiment 7

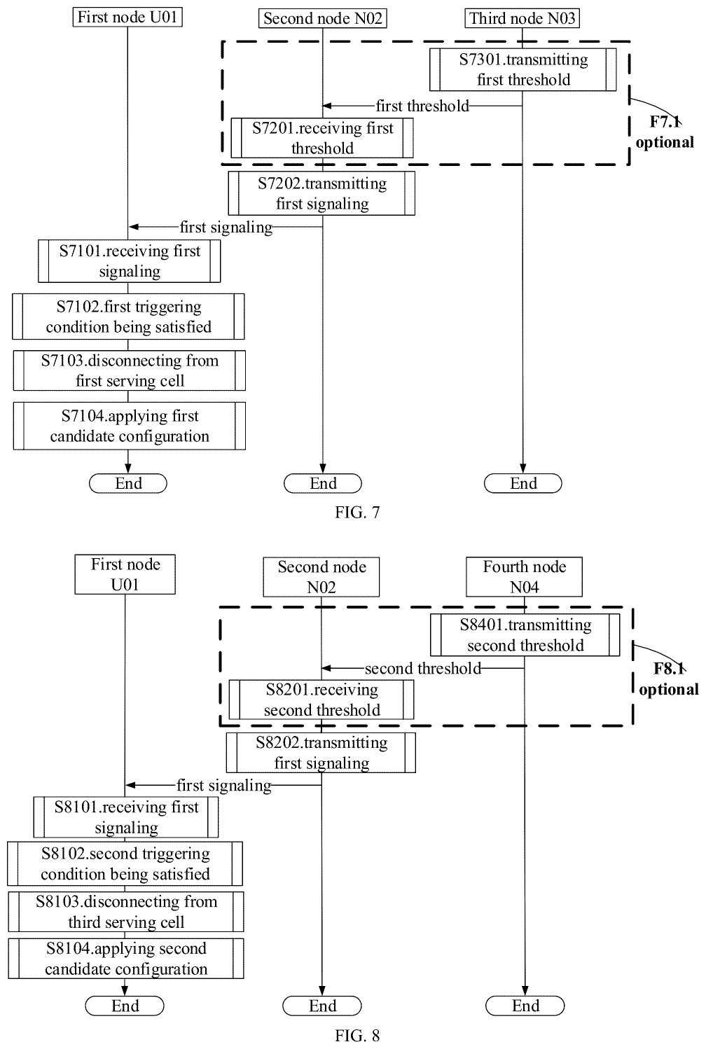

Embodiment 7 illustrates a flowchart of radio signal transmission of a first threshold according to one embodiment of the present application, as shown in FIG. 7. It should be particularly noted that the sequence illustrated herein does not set any limit to the signal transmission order or implementation order in the present application.

The first node U01 receives a first signaling in step S7101, the first signaling being used to indicate a first condition set, the first condition set including multiple triggering conditions: determines in step S7102 that a first triggering condition is satisfied; and in step S7103, disconnects from the first serving cell as a response to the first triggering condition being satisfied; and in step S7104, applies a first candidate configuration as a response to the first triggering condition being satisfied.

The second node N02 receives a first threshold in step S7201; and transmits the first signaling in step S7202.

The third node N03 transmits the first threshold in step S7301.

In Embodiment 7, the first triggering condition comprises that at least a measurement result for the second serving cell is greater than a first threshold: the first signaling comprises the first threshold; the first candidate configuration includes configuration information for a second serving cell, the first serving cell and the second serving cell each being a SpCell: the first triggering condition being satisfied occurs after receiving the first signaling, the first triggering condition is a triggering condition in a first condition subset, and the first condition subset is a proper subset of the first condition set: the first condition subset is related to the first serving cell.

In one embodiment, the first triggering condition is related to the first threshold.

In one embodiment, the first condition subset is related to the first threshold.

In one embodiment, the first condition subset is related to the first threshold and the second departure threshold.

In one embodiment, the first triggering condition comprises an event A3.

In one embodiment, the first triggering condition comprises an event A4.

In one embodiment, the first triggering condition comprises an event A5.

In one embodiment, the first triggering condition comprises a measurement result for the second serving cell being greater than a first threshold; the first threshold is configured by a maintenance base station of the second serving cell.

In one embodiment, the first triggering condition comprises that a measurement result for the second serving cell is greater than a first threshold and a measurement result for the first serving cell is less than a second departure threshold; the first departure threshold is configured by a maintenance base station of the first serving cell: the first threshold is configured by a maintenance base station of the second serving cell.

In one embodiment, the first triggering condition comprises a measurement result for the second serving cell being greater than a first threshold; the first threshold is configured by a maintenance base station of the first serving cell.

In one embodiment, the first triggering condition comprises that a measurement result for the second serving cell is greater than a first threshold and a measurement result for the first serving cell is less than a second departure threshold: the first departure threshold is configured by a maintenance base station of the first serving cell: the first threshold is configured by a maintenance base station of the first serving cell.

In one embodiment, a measurement result for a cell includes at least one offset.

In one embodiment, a measurement result for a cell does not include the at least one offset.

In one embodiment, the one offset includes Hys.

In one embodiment, the one offset includes Ofp.

In one embodiment, the one offset includes Ocp.

In one embodiment, the one offset includes Off.

In one embodiment, the one offset includes Ocn.

In one embodiment, the one offset is measured in dB.

In one embodiment, the dashed-line box F7.1 is optional.

In one embodiment, the dashed-line box F7.1 is present.

In one subembodiment, the first threshold is configured by a maintenance base station of the second serving cell.

In one subembodiment, the first threshold is transmitted in a SN addition request acknowledgment message.

In one subembodiment, the SN addition request acknowledgment message is used for acknowledging to the second node N02 addition preparation by the third node N03.

In one subembodiment, the SN addition request acknowledgment message comprises a SN Addition Request Acknowledge message.

In one subembodiment, the SN addition request acknowledgment message comprises a S-NODE ADDITION REQUEST ACKNOWLEDGE message.

In one subembodiment, the SN addition request acknowledgment message comprises an indication of full RRC configuration or delta RRC configuration.

In one subembodiment, the SN addition request acknowledgment message comprises a PDU Session Resources Admitted To Be Added List.

In one subembodiment, the SN addition request acknowledgment message comprises a M-NG-RAN node UE XnAP ID.

In one subembodiment, the SN addition request acknowledgment message comprises a PDU Session ID.

In one subembodiment, the first threshold is an RRC field in the SN addition request acknowledgment message.

In one subembodiment, the first threshold is an RRC field of a CG-Config message in the SN addition request acknowledgment message.

In one embodiment, the dashed-line box F7.1 does not exist.

In one subembodiment, the first threshold is configured by a maintenance base station of the first serving cell.

### Embodiment 8

Embodiment 8 illustrates a flowchart of radio signal transmission of a second threshold according to one embodiment of the present application, as shown in FIG. 8. It should be particularly noted that the sequence illustrated herein does not set any limit to the signal transmission order or implementation order in the present application.

The first node U01 receives a first signaling in step S8101, the first signaling being used to indicate a first condition set, the first condition set including multiple triggering conditions: determines in step S8102 that a second triggering condition is satisfied; and in step S8103, disconnects from the third serving cell as a response to the second triggering condition being satisfied; and in step S8104, applies a second candidate configuration as a response to the second triggering condition being satisfied.

The second node N02 receives a second threshold in step S8201; and transmits the first signaling in step S8202.

The fourth node N04 transmits the second threshold in step S8401.

In one embodiment, the second triggering condition is related to the second threshold.

In one embodiment, the third condition subset is related to the second threshold.

In one embodiment, the third condition subset is related to the second threshold and the third departure threshold.

In one embodiment, the first triggering condition comprises an event A3.

In one embodiment, the first triggering condition comprises an event A4.

In one embodiment, the first triggering condition comprises an event A5.

In one embodiment, the first triggering condition comprises a measurement result for the second serving cell being greater than a first threshold: the first threshold is configured by a maintenance base station of the second serving cell.

In one embodiment, the first triggering condition comprises that a measurement result for the second serving cell is greater than a first threshold and a measurement result for the first serving cell is less than a second departure threshold: the first departure threshold is configured by a maintenance base station of the first serving cell: the first threshold is configured by a maintenance base station of the second serving cell.

In one embodiment, the first triggering condition comprises a measurement result for the second serving cell being greater than a first threshold: the first threshold is configured by a maintenance base station of the first serving cell.

In one embodiment, the first triggering condition comprises that a measurement result for the second serving cell is greater than a first threshold and a measurement result for the first serving cell is less than a second departure threshold: the first departure threshold is configured by a maintenance base station of the first serving cell: the first threshold is configured by a maintenance base station of the first serving cell.

In one embodiment, a measurement result for a cell includes at least one offset.

In one embodiment, a measurement result for a cell does not include the at least one offset.

In one embodiment, the dashed-line box F8.1 is optional.

In one embodiment, the dashed-line box F8.1 is present.

In one subembodiment, the second threshold is configured by a maintenance base station of the first serving cell.

In one subembodiment, the second threshold is transmitted in a SN addition request acknowledgment message.

In one subembodiment, the SN addition request acknowledgment message is used for acknowledging to the second node N02 addition preparation by the fourth node N04.

In one subembodiment, the second threshold is an RRC field in the SN addition request acknowledgment message.

In one subembodiment, the second threshold is an RRC field of a CG-Config message in the SN addition request acknowledgment message.

In one embodiment, the dashed-line box F8.1 does not exist.

In one subembodiment, the second threshold is configured by a maintenance base station of the third serving cell.

### Embodiment 9

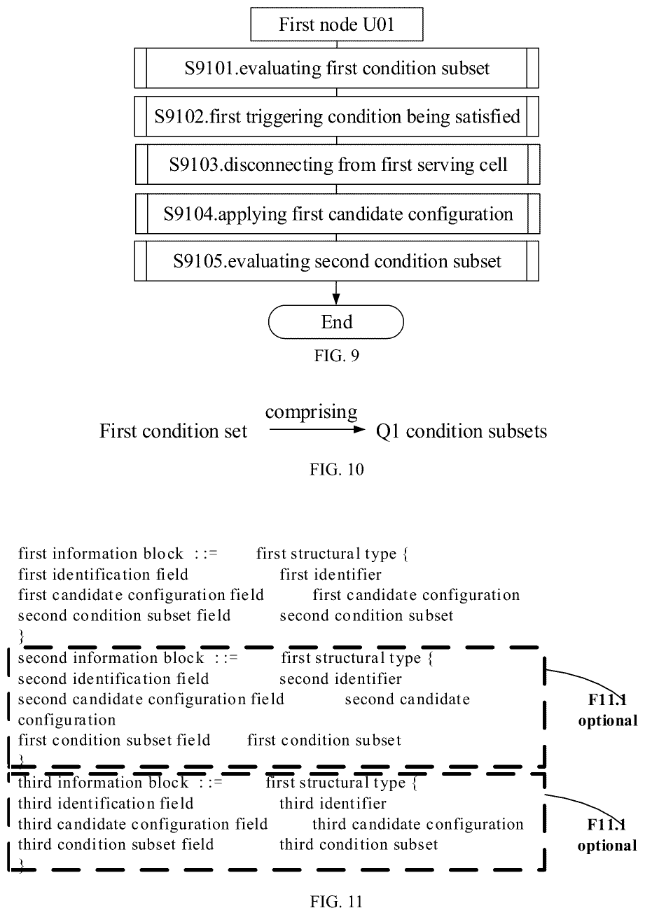

Embodiment 9 illustrates a flowchart of radio signal transmission of evaluating a second condition subset after successful application of a first candidate configuration according to one embodiment of the present application, as shown in FIG. 9.

The first node U01 evaluates a first condition subset in step S9101; and in step S9102, determines that a first triggering condition is satisfied: in step S9103, as a response to the first triggering condition being satisfied, disconnects from a first serving cell: in step S9104, as a response to the first triggering condition being satisfied, applies a first candidate configuration; and in step S9105, after the first candidate configuration is successfully applied, evaluates a second condition subset.

In Embodiment 9, the second condition subset is a proper subset of the first condition set; the second condition subset is related to the second serving cell.

In one embodiment, stop evaluating the first condition subset after successful application of the first candidate configuration.

In one embodiment, start evaluating the second condition subset and stop evaluating the first condition subset.

In one embodiment, the first condition subset is evaluated before determining that the first triggering condition is satisfied.

In one embodiment, during the time that the first serving cell is a serving cell of the first node U01, evaluating the first condition subset.

In one embodiment, before disconnecting from the first serving cell, evaluating the first condition subset.

In one embodiment, the second condition subset is evaluated after the first candidate configuration has been successfully applied: where the first condition subset is not evaluated.

In one embodiment, successful synchronization with the second serving cell is used to determine that the first candidate configuration is successfully applied.

In one embodiment, reception of a physical layer acknowledgement message for the third signaling is used to determine that the first candidate configuration is successfully applied.

In one embodiment, successful completion of a random access procedure on the second serving cell is used to determine that the first candidate configuration is successfully applied.

In one embodiment, the action of evaluating a second condition subset comprises: evaluating each triggering condition in the second condition subset.

In one embodiment, the action of evaluating a second condition subset comprises: determining whether each triggering condition in the second condition subset is satisfied.

In one embodiment, after the action of applying the first candidate configuration, a signaling is received, the signaling indicating the second condition subset.

In one embodiment, after the action of applying the first candidate configuration, a signaling is received, the signaling indicating the third candidate cell set.

In one embodiment, the above signaling is an RRC signaling.

In one embodiment, the above signaling is a MAC-layer signaling.

In one embodiment, a cell identity of the second serving cell is used to determine the third candidate cell set.

In one embodiment, the above signaling indicates candidate cells in the third candidate cell set.

In one embodiment, the indication of the above signaling includes cell identities of candidate cells in the third candidate cell set.

In one embodiment, the indication of the above signaling includes identifiers of candidate cells in the third candidate cell set.

In one embodiment, the indication of the above signaling includes a bitmap indicating candidate cells in the third candidate cell set.

In one subembodiment, one bit in the bitmap corresponds to one cell.

In one subembodiment, if one bit in the bitmap is set to 1, the one bit corresponds to a cell that is a candidate cell in the third candidate cell set.

In one subembodiment, if one bit in the bitmap is set to 0, the one bit corresponds to a cell that is not a candidate cell in the third candidate cell set.

In one embodiment, a format of the above signaling is the same as a format of the second signaling.

In one embodiment, the name of the above signaling is the same as the name of the second signaling.

In one embodiment, the third candidate cell set is used to determine the second condition subset.

Typically, a cell identity of the second serving cell is used to determine the second condition subset from the first condition set.

In one embodiment, the first signaling indicates the second condition subset.

In one embodiment, the first signaling indicates the second condition subset, and the second signaling indicates the first condition subset.

In one embodiment, the first signaling indicates the second condition subset and the first condition subset.

In one embodiment, the third serving cell is the second serving cell: the second condition subset is the third condition subset, and the first candidate configuration is configuration information for the third serving cell.

### Embodiment 10

Embodiment 10 illustrates a schematic diagram of a first condition set including Q1 condition subsets according to one embodiment of the present application.

In Embodiment 10, the first condition set includes Q1 condition subsets, and the first serving cell is one of Q1 cells, the Q1 condition subsets being respectively associated with the Q1 cells, Q1 being a positive integer greater than 1.

In one embodiment, Q1 is not greater than MI, MI being a positive integer.

In one embodiment, MI is equal to 8.

In one embodiment, Ml is equal to 16.

In one embodiment, MI is equal to 7.

In one embodiment, MI is equal to 15.

In one embodiment, MI is pre-configured.

In one embodiment, MI is of fixed size.

In one embodiment, the first variable includes the Q1 condition subsets.

In one embodiment, XXX included in the first variable includes the Q1 condition subsets.

### Embodiment 11

Embodiment 11 illustrates a schematic diagram of the structure of an information block according to one embodiment of the present application, as shown in FIG. 11. In FIG. 11, the symbol “::=” indicates being defined as or equivalent to.

In Embodiment 11, the first signaling includes at least the first information block of a first information block, a second information block and a third information block.

In one embodiment, the first signaling comprises the first information block.

In one embodiment, the first signaling includes the first information block, the second information block, and the third information block.

In one embodiment, the first signaling includes the second information block and the third information block, while the second signaling includes the second information block.

In one embodiment, the first structural type comprises SEQUENCE.

In one embodiment, the first structural type comprises CHOICE.

In one embodiment, the first information block comprises at least one of a first identifier, a first candidate configuration, or a second condition subset; the first identifier indicates the second serving cell.

In one embodiment, the second information block comprises at least one of a second identifier, a second candidate configuration, or a first condition subset: the second identifier indicates the first serving cell.

In one embodiment, the third information block comprises at least one of a third identifier, a third candidate configuration, or a third condition subset: the third identifier indicates the third serving cell.

In one embodiment, the third candidate configuration includes configuration information of the third serving cell.

In one embodiment, an RRC IE or an RRC field in the first information block indicates the second condition subset.

In one embodiment, an RRC IE or an RRC field in the second information block indicates the first condition subset.

In one embodiment, an RRC IE or an RRC field in the third information block indicates the third condition subset.

In one embodiment, a second condition subset field in the first information block indicates the second condition subset.

In one embodiment, a first condition subset field in the second information block indicates the first condition subset.

In one embodiment, a third condition subset field in the third information block indicates the third condition subset.

In one embodiment, the dashed-line box F11.1 is optional.

In one embodiment, the dashed-line box F11.1 exists.

In one embodiment, at least part of the dashed-line box F11.1 does not exist.

In one embodiment, the dashed-line box F11.2 is optional.

In one embodiment, the dashed-line box F11.2 exists.

In one embodiment, at least part of the dashed-line box F11.2 does not exist.

In one embodiment, the second identifier is a non-negative integer.

In one embodiment, the second identifier is a positive integer.

In one embodiment, the second identifier is a PCI of the first serving cell.

In one embodiment, the second identifier is a cell group identity of a cell group to which the first serving cell belongs.

In one embodiment, the second identifier is used to indicate the first serving cell.

In one embodiment, the second identifier is used to determine that the second candidate configuration is that of the first serving cell.

In one embodiment, the first identifier is different from the second identifier.

In one embodiment, the first identifier is unequal to the second identifier.

In one embodiment, the third identifier is a non-negative integer.

In one embodiment, the third identifier is a positive integer.

In one embodiment, the third identifier is a PCI of the third serving cell.

In one embodiment, the third identifier is a cell group identity of a cell group to which the third serving cell belongs.

In one embodiment, the third identifier is used to indicate the third serving cell.

In one embodiment, the third identifier is used to determine that the third candidate configuration is that of the third serving cell.

In one embodiment, the third identifier is different from the first identifier.

In one embodiment, the third identifier is different from the second identifier.

In one embodiment, the third identifier is the same as the second identifier.

### Embodiment 12

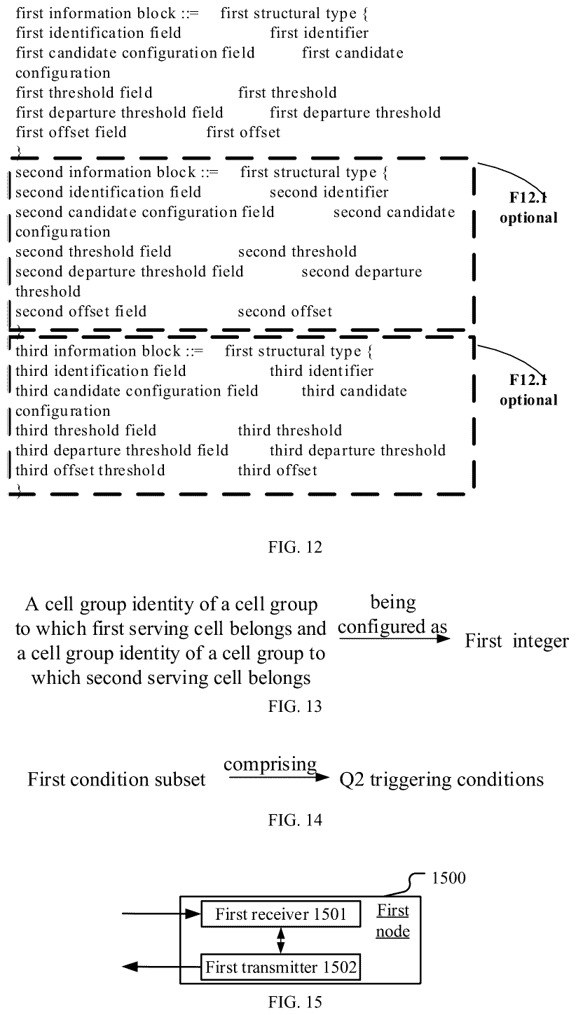

Embodiment 12 illustrates a schematic diagram of the structure of an information block according to another embodiment of the present application, as shown in FIG. 12. In FIG. 12, the symbol “::=” indicates being defined as or equivalent to.

In Embodiment 12, the first signaling includes at least the first information block of a first information block, a second information block, or a third information block.

In one embodiment, the first signaling includes at least the first information block and the second information block of a first information block, a second information block and a third information block. In one embodiment, the first signaling comprises the first information block.

In one embodiment, the first signaling comprises the first information block and the second information block.

In one embodiment, the first signaling comprises the first information block, while the second signaling comprises the second information block.

In one embodiment, the second information block is an RRC field in the first signaling.

In one embodiment, the second information block is an RRC IE in the first signaling.

In one embodiment, the second information block comprises at least one RRC field.

In one embodiment, the second information block comprises at least one RRC IE.

In one embodiment, the third information block is an RRC field in the first signaling.

In one embodiment, the third information block is an RRC IE in the first signaling.

In one embodiment, the third information block comprises at least one RRC field.

In one embodiment, the third information block comprises at least one RRC IE.

In one embodiment, the first information block comprises at least a first identifier and a first candidate configuration: the first identifier indicates the second serving cell.

In one embodiment, the first information block comprises at least a first identifier, a first candidate configuration and the first threshold: the first identifier indicates the second serving cell.

In one embodiment, the first information block comprises at least a first identifier, a first candidate configuration and the first offset: the first identifier indicates the second serving cell.

In one embodiment, the first information block comprises at least a first identifier, a first candidate configuration, the first threshold and a first departure threshold: the first identifier indicates the second serving cell.

In one embodiment, the first information block comprises at least a first identifier, a first candidate configuration and a second condition subset: the first identifier indicates the second serving cell.

In one embodiment, the first offset is the offset in this application.

In one embodiment, the second information block comprises at least a second identifier and a second candidate configuration: the second identifier indicates the first serving cell.

In one embodiment, the second information block comprises at least a second identifier, a second candidate configuration and the second threshold: the second identifier indicates the first serving cell.

In one embodiment, the second information block comprises at least a second identifier, a second candidate configuration and the second offset: the second identifier indicates the first serving cell.

In one embodiment, the second information block comprises at least a second identifier, a second candidate configuration, the second threshold and the second departure threshold: the second identifier indicates the first serving cell.

In one embodiment, the second information block comprises at least a second identifier, a second candidate configuration and a first condition subset: the second identifier indicates the first serving cell.

In one embodiment, the second offset is the offset in this application.

In one embodiment, the third information block comprises at least a third identifier and a third candidate configuration: the third identifier indicates the third serving cell.

In one embodiment, the third information block comprises at least a third identifier, a third candidate configuration and the third threshold: the third identifier indicates the third serving cell.

In one embodiment, the third information block comprises at least a third identifier, a third candidate configuration and the third offset: the third identifier indicates the first serving cell.

In one embodiment, the third information block comprises at least a third identifier, a third candidate configuration, the third threshold and the third departure threshold: the third identifier indicates the third serving cell.

In one embodiment, the third information block comprises at least a third identifier, a third candidate configuration and a third condition subset: the third identifier indicates the third serving cell.

In one embodiment, the third offset is the offset in this application.

In one embodiment, an RRC IE or an RRC field in the first information block indicates the first threshold.

In one embodiment, an RRC IE or an RRC field in the first information block indicates the first departure threshold.

In one embodiment, an RRC IE or an RRC field in the first information block indicates the first offset.

In one embodiment, a first identification field in the first information block indicates the first identifier.

In one embodiment, a first candidate configuration field in the first information block indicates the first candidate configuration.

In one embodiment, a first threshold field in the first information block indicates the first threshold.

In one embodiment, a first departure threshold field in the first information block indicates the first departure threshold.

In one embodiment, a first offset field in the first information block indicates the first offset.

In one embodiment, an RRC IE or an RRC field in the second information block indicates the second identifier.

In one embodiment, an RRC IE or an RRC field in the second information block indicates the second candidate configuration.

In one embodiment, an RRC IE or an RRC field in the second information block indicates the second threshold.

In one embodiment, an RRC IE or an RRC field in the second information block indicates the second departure threshold.

In one embodiment, an RRC IE or an RRC field in the second information block indicates the second offset.

In one embodiment, a second identification field in the second information block indicates the second identifier.

In one embodiment, a second candidate configuration field in the second information block indicates the second candidate configuration.

In one embodiment, a second threshold field in the second information block indicates the second threshold.

In one embodiment, a second departure threshold field in the second information block indicates the second departure threshold.

In one embodiment, a second offset field in the second information block indicates the second offset. In one embodiment, an RRC IE or an RRC field in the third information block indicates the third identifier.

In one embodiment, an RRC IE or an RRC field in the third information block indicates the third candidate configuration.

In one embodiment, an RRC IE or an RRC field in the third information block indicates the third threshold.

In one embodiment, an RRC IE or an RRC field in the third information block indicates the third departure threshold.

In one embodiment, an RRC IE or an RRC field in the third information block indicates the third offset.

In one embodiment, a third identification field in the third information block indicates the third identifier.

In one embodiment, a third candidate configuration field in the third information block indicates the third candidate configuration.

In one embodiment, a third threshold field in the third information block indicates the third threshold.

In one embodiment, a third departure threshold field in the third information block indicates the third departure threshold.

In one embodiment, a third offset field in the third information block indicates the third offset.

In one embodiment, the first triggering condition comprises a measurement result for the second serving cell being greater than a measurement result for the first serving cell.

In one embodiment, the first triggering condition comprises the sum of a measurement result for the second serving cell plus a first offset being greater than a measurement result for the first serving cell.

In one embodiment, the first triggering condition comprises a measurement result for the second serving cell being greater than a first threshold.

In one embodiment, the first triggering condition comprises a measurement result for the second serving cell being greater than a first threshold, and, a measurement result for the first serving cell being less than a second departure threshold.

In one embodiment, a triggering condition in the first condition subset comprises a measurement result for the third serving cell being greater than a measurement result for the first serving cell: the first condition subset comprising the first triggering condition: the second serving cell and the third serving cell being different.

In one embodiment, a triggering condition in the first condition subset comprises a measurement result for the third serving cell being greater than a third threshold: the first condition subset comprising the first triggering condition: the second serving cell and the third serving cell being different.

In one embodiment, a triggering condition in the first condition subset comprises a measurement result for the third serving cell being greater than a third threshold and, a measurement result for the first serving cell being less than a second departure threshold: the first condition subset comprising the first triggering condition: the second serving cell and the third serving cell being different.

In one embodiment, the second triggering condition comprises a measurement result for the first serving cell being greater than a measurement result for the third serving cell.

In one embodiment, the second triggering condition comprises a measurement result for the first serving cell being greater than a second threshold.

In one embodiment, the second triggering condition comprises a measurement result for the first serving cell being greater than a second threshold, and, a measurement result for the third serving cell being less than a third departure threshold.

In one embodiment, a triggering condition in the second condition subset comprises a measurement result for the second serving cell being greater than a measurement result for the third serving cell: the third condition subset comprising the second triggering condition: the second serving cell and the third serving cell being different.

In one embodiment, a triggering condition in the second condition subset comprises a measurement result for the second serving cell being greater than a first threshold: the third condition subset comprising the second triggering condition: the second serving cell and the third serving cell being different.

In one embodiment, a triggering condition in the second condition subset comprises a measurement result for the second serving cell being greater than a first threshold, and a measurement result for the third serving cell being less than a third departure threshold: the third condition subset comprising the second triggering condition: the second serving cell and the third serving cell being different.

In one embodiment, the second serving cell is the same as the third serving cell.

In one subembodiment, the second condition subset is the third condition subset.

In one subembodiment, the first identifier is the third identifier.

In one subembodiment, the first information block is the third information block.

In one subembodiment, the first threshold is the third threshold.

In one subembodiment, the first departure threshold is the third departure threshold.

In one subembodiment, the first candidate configuration is the third candidate configuration.

In one embodiment, the second serving cell is different from the third serving cell.

In one subembodiment, the second condition subset is not the third condition subset.

In one subembodiment, the first identifier is not the third identifier.

In one subembodiment, the first information block is not the third information block.

In one subembodiment, the first threshold is not the third threshold.

In one subembodiment, the first departure threshold is not the third departure threshold.

In one subembodiment, the first candidate configuration is not the third candidate configuration.

In one embodiment, the dashed-line box F12.1 is optional.

In one embodiment, the dashed-line box F12.1 exists.

In one embodiment, at least part of the dashed-line box F12.1 does not exist.

In one embodiment, the dashed-line box F12.2 is optional.

In one embodiment, the dashed-line box F12.2 exists.

In one embodiment, at least part of the dashed-line box F12.2 does not exist.

In one embodiment, as a response to receiving the first information block, the first information block is stored in the first variable.

In one embodiment, the first information block, the second information block and the third information block belong to multiple different RRC messages.

In one embodiment, at least one of the first threshold field, or the first departure threshold field, or the first offset field is present.

In one embodiment, at least one of the first threshold field, or the first departure threshold field, or the first offset field, or the first candidate configuration field is not present.

In one embodiment, the first threshold field, or the first departure threshold field, or the first offset field, or the first candidate configuration field is optional.

### Embodiment 13

Embodiment 13 illustrates a schematic diagram of a cell group identity of a cell group to which a first serving cell belongs and a cell group identity of a cell group to which a second serving cell belongs being configured as a first integer according to one embodiment of the present application, as shown in FIG. 13.

In Embodiment 13, a cell group identity of a cell group to which the first serving cell belongs is configured as a first integer, and a cell group identity of a cell group to which the second serving cell belongs is configured as the first integer.

In one embodiment, the cell group identity is used to identify a cell group.

In one embodiment, the cell group identity is identified by a CellGroupId.

In one embodiment, the first integer is greater than 0.

Typically, the cell group identity of a cell group to which any of the Q1 cells belongs is configured as a first integer.

In one embodiment, the first integer is equal to 0.

In one embodiment, the first integer is equal to 1.

In one embodiment, the first integer is an integer not less than 1 and not greater than K1, K1 being a positive integer greater than 1.

In one embodiment, K1 is equal to 8.

In one embodiment, K1 is equal to 4.

In one embodiment, K1 is pre-configured.

In one embodiment, K1 is configurable.

In one embodiment, K1 is equal to a number of SCGs configured for the first node.

In one embodiment, the cell group to which the first serving cell belongs includes at least the first serving cell.

In one embodiment, the cell group to which the first serving cell belongs includes only the first serving cell.

In one embodiment, the cell group to which the first serving cell belongs includes the first serving cell and at least one SCell.

In one embodiment, the cell group to which the second serving cell belongs includes at least the second serving cell.

In one embodiment, the cell group to which the second serving cell belongs includes only the second serving cell.

In one embodiment, the cell group to which the second serving cell belongs includes the second serving cell and at least one SCell.

### Embodiment 14

Embodiment 14 illustrates a schematic diagram of a first condition subset including Q2 triggering conditions according to one embodiment of the present application, as shown in FIG. 14.

In one embodiment, the first condition subset includes Q2 triggering conditions, and the second serving cell is one of Q2 cells, the Q2 triggering conditions being respectively associated with the Q2 cells, Q2 being a positive integer greater than 1.

In one embodiment, Q2 is not greater than Q1.

In one embodiment, Q2 is not greater than the difference between Q1 and 1.

In one embodiment, Q2 is less than Q1.

In one embodiment, the Q2 cells are associated with Q2 configuration identifiers, each of the Q2 configuration identifiers corresponding to one of the Q2 cells.

In one embodiment, the configuration identifier is configured by an RRC IE, the RRC IE including CondReconfigId in its name.

In one embodiment, the configuration identifier is configured by an RRC IE, the RRC IE including in its name at least one of SCG or CPC or group or cond or Reconfig or Id.

In one embodiment, the configuration identifier comprises a positive integer.

In one embodiment, the configuration identifier comprises a non-negative integer.

In one embodiment, the configuration identifier is an integer not less than 0 and not greater than Q2-1.

In one embodiment, the configuration identifier is an integer not less than 1 and not greater than Q2. In one embodiment, the configuration identifier comprises a PCI.

In one embodiment, the configuration identifier comprises a CellGroupId.

In one embodiment, the configuration identifier comprises a CondReconfigId.

In one embodiment, the configuration identifier is configured by an RRC IE, the RRC IE including CellGroupId in its name.

### Embodiment 15

Embodiment 15 illustrates a structure block diagram of a processing device used in a first node according to one embodiment of the present application, as shown in FIG. 15. In FIG. 15, a processing device 1500 in a first node is comprised of a first receiver 1501 and a first transmitter 1502.

The first receiver 1501 receives a first signaling, the first signaling being used to indicate a first condition set, the first condition set including multiple triggering conditions:

the first processor, as a response to a first triggering condition being satisfied, disconnects from a first serving cell and applying a first candidate configuration, the first candidate configuration including configuration information for a second serving cell, the first serving cell and the second serving cell each being a SpCell.

In Embodiment 15, the first triggering condition being satisfied occurs after receiving the first signaling, the first triggering condition is a triggering condition in a first condition subset, and the first condition subset is a proper subset of the first condition set: the first condition subset is related to the first serving cell.

In one embodiment, the first processor comprises at least one of the first transmitter 1502 or the first receiver 1501.

In one embodiment, the first condition set includes Q1 condition subsets, and the first serving cell is one of Q1 cells, the Q1 condition subsets being respectively associated with the Q1 cells, Q1 being a positive integer greater than 1.

In one embodiment, the first processor is synchronized to the second serving cell as a response to the first triggering condition being satisfied: the first transmitter 1502 transmits a third signaling: where the third signaling includes information that is used to confirm successful access to the second serving cell.

In one embodiment, the first triggering condition comprises that at least a measurement result for the second serving cell is greater than a first threshold: the first signaling comprises the first threshold: the first threshold is configured by a maintenance base station of the first serving cell, or, the first threshold is configured by a maintenance base station of the second serving cell.

In one embodiment, the first processor, as a response to a second triggering condition being satisfied, disconnects from a third serving cell and applies a second candidate configuration, the second candidate configuration including configuration information for the first serving cell, the third serving cell being a SpCell: where the action of receiving the first signaling occurs before the second triggering condition being satisfied.

In one embodiment, the first receiver 1501 receives a second signaling, the second signaling being used to indicate the first condition set: herein, the action of receiving the second signaling occurs after the second triggering condition being satisfied.

In one embodiment, the first processor is synchronized to the first serving cell as a response to the second triggering condition being satisfied: the first transmitter 1502 transmits a fourth signaling: where the fourth signaling includes information that is used to confirm successful access to the first serving cell.

In one embodiment, the second triggering condition comprises that at least a measurement result for the first serving cell is greater than a second threshold: the first signaling comprises the second threshold; the second threshold is configured by a maintenance base station of the third serving cell, or, the second threshold is configured by a maintenance base station of the first serving cell.

In one embodiment, a cell group identity of a cell group to which the first serving cell belongs is configured as a first integer, and a cell group identity of a cell group to which the second serving cell belongs is configured as the first integer.

In one embodiment, the first condition subset includes Q2 triggering conditions, and the second serving cell is one of Q2 cells, the Q2 triggering conditions being respectively associated with the Q2 cells, Q2 being a positive integer greater than 1.

In one embodiment, the first receiver 1501 evaluates a second condition subset after successful application of the first candidate configuration: herein, the second condition subset is a proper subset of the first condition set: the second condition subset is related to the second serving cell.

In one embodiment, the first receiver 1501 comprises the antenna 452, the receiver 454, the multi-antenna receiving processor 458, the receiving processor 456, the controller/processor 459, the memory 460 and the data source 467 in FIG. 4 of the present application.

In one embodiment, the first receiver 1501 comprises the antenna 452, the receiver 454, the multi-antenna receiving processor 458 and the receiving processor 456 in FIG. 4 of the present application.

In one embodiment, the first receiver 1501 comprises the antenna 452, the receiver 454 and the receiving processor 456 in FIG. 4 of the present application.

In one embodiment, the first transmitter 1502 comprises the antenna 452, the transmitter 454, the multi-antenna transmitting processor 457, the transmitting processor 468, the controller/processor 459, the memory 460 and the data source 467 in FIG. 4 of the present application.

In one embodiment, the first transmitter 1502 comprises the antenna 452, the transmitter 454, the multi-antenna transmitting processor 457 and the transmitting processor 468 in FIG. 4 of the present application.

In one embodiment, the first transmitter 1502 comprises the antenna 452, the transmitter 454 and the transmitting processor 468 in FIG. 4 of the present application.

### Embodiment 16

Embodiment 16 illustrates a structure block diagram of a processing device used in a second node according to one embodiment of the present application, as shown in FIG. 16. In FIG. 16, a processing device 1600 in a second node is comprised of a second transmitter 1601 and a second receiver 1602.

The first transmitter 1601 transmits a first signaling, the first signaling being used to indicate a first condition set, the first condition set including multiple triggering conditions.

In Embodiment 16, as a response to a first triggering condition being satisfied, a first serving cell is disconnected and a first candidate configuration is applied, the first candidate configuration including configuration information for a second serving cell, the first serving cell and the second serving cell each being a SpCell: the first triggering condition being satisfied occurs after receiving the first signaling, the first triggering condition is a triggering condition in a first condition subset, and the first condition subset is a proper subset of the first condition set: the first condition subset is related to the first serving cell.

In one embodiment, the first condition set includes Q1 condition subsets, and the first serving cell is one of Q1 cells, the Q1 condition subsets being respectively associated with the Q1 cells, Q1 being a positive integer greater than 1.

In one embodiment, as a response to the first triggering condition being satisfied, a receiver of the first signaling is synchronized to the second serving cell: a third signaling is transmitted by the receiver of the first signaling: where the third signaling includes information that is used to confirm successful access to the second serving cell.

In one embodiment, the second receiver 1602 receives the third signaling: the second transmitter 1601 transmits a fifth signaling: herein, the third signaling is used to trigger the fifth signaling, the fifth signaling comprising at least a portion of the third signaling, a receiver of the fifth signaling being a maintenance base station of the second serving cell.

In one embodiment, the first triggering condition comprises that at least a measurement result for the second serving cell is greater than a first threshold: the first signaling comprises the first threshold: the first threshold is configured by a maintenance base station of the first serving cell, or, the first threshold is configured by a maintenance base station of the second serving cell.

In one embodiment, the second receiver 1602 receives the first threshold; herein, the first threshold is configured by a maintenance base station of the second serving cell.

In one embodiment, as a response to a second triggering condition being satisfied, a third serving cell is disconnected and a second candidate configuration is applied, the second candidate configuration including configuration information for the first serving cell, the third serving cell being a SpCell: where the action of receiving the first signaling occurs before the second triggering condition being satisfied.

In one embodiment, a second signaling is received, the second signaling being used to indicate the first condition set: herein, the action of receiving the second signaling occurs after the second triggering condition being satisfied.

In one embodiment, the second transmitter 1601 transmits a second signaling.

In one embodiment, as a response to the second triggering condition being satisfied, a receiver of the first signaling is synchronized to the first serving cell: a fourth signaling is transmitted: where the fourth signaling includes information that is used to confirm successful access to the first serving cell.

In one embodiment, the second receiver 1602 receives a fourth signaling: the second transmitter 1601 transmits a sixth signaling: herein, the fourth signaling is used to trigger the sixth signaling, the sixth signaling comprising at least a portion of the fourth signaling, a receiver of the sixth signaling being a maintenance base station of the first serving cell.

In one embodiment, the second triggering condition comprises that at least a measurement result for the first serving cell is greater than a second threshold: the first signaling comprises the second threshold: the second threshold is configured by a maintenance base station of the third serving cell, or, the second threshold is configured by a maintenance base station of the first serving cell.

In one embodiment, the second receiver 1602 receives the second threshold: herein, the second threshold is configured by a maintenance base station of the first serving cell.

In one embodiment, a cell group identity of a cell group to which the first serving cell belongs is configured as a first integer, and a cell group identity of a cell group to which the second serving cell belongs is configured as the first integer.

In one embodiment, the first condition subset includes Q2 triggering conditions, and the second serving cell is one of Q2 cells, the Q2 triggering conditions being respectively associated with the Q2 cells, Q2 being a positive integer greater than 1.

In one embodiment, a second condition subset is evaluated after successful application of the first candidate configuration: herein, the second condition subset is a proper subset of the first condition set: the second condition subset is related to the second serving cell.

In one embodiment, the second transmitter 1601 comprises the antenna 420, the transmitter 418, the multi-antenna transmitting processor 471, the transmitting processor 416, the controller/processor 475 and the memory 476 in FIG. 4 of the present application.

In one embodiment, the second transmitter 1601 comprises the antenna 420, the transmitter 418, the multi-antenna transmitting processor 471 and the transmitting processor 416 in FIG. 4 of the present application.

In one embodiment, the second transmitter 1601 comprises the antenna 420, the transmitter 418 and the transmitting processor 416 in FIG. 4 of the present application.

In one embodiment, the second receiver 1602 comprises the antenna 420, the receiver 418, the multi-antenna receiving processor 472, the receiving processor 470, the controller/processor 475 and the memory 476 in FIG. 4 of the present application.

In one embodiment, the second receiver 1602 comprises the antenna 420, the receiver 418, the multi-antenna receiving processor 472 and the receiving processor 470 in FIG. 4 of the present application.

In one embodiment, the second receiver 1602 comprises the antenna 420, the receiver 418 and the receiving processor 470 in FIG. 4 of the present application.

### Embodiment 17

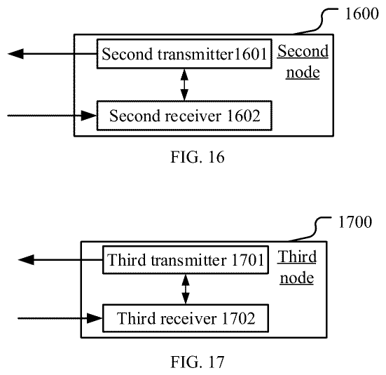

Embodiment 17 illustrates a structure block diagram of a processing device used in a second node according to one embodiment of the present application, as shown in FIG. 17. In FIG. 17, a processing device 1700 in the second node is comprised of a third transmitter 1701 and a third receiver 1702.

The third processor has a receiver of a first signaling synchronizing to a second serving cell as a response to a first triggering condition being satisfied.

In Embodiment 17, the first signaling is used to indicate a first condition set, the first condition set including multiple triggering conditions: as a response to a first triggering condition being satisfied, a first serving cell is disconnected and a first candidate configuration is applied, the first candidate configuration including configuration information for the second serving cell, the first serving cell and the second serving cell each being a SpCell: the first triggering condition being satisfied occurs after receiving the first signaling, the first triggering condition is a triggering condition in a first condition subset, and the first condition subset is a proper subset of the first condition set: the first condition subset is related to the first serving cell.

In one embodiment, the third processor comprises at least one of the third transmitter 1701 or the third receiver 1702.

In one embodiment, the first condition set includes Q1 condition subsets, and the first serving cell is one of Q1 cells, the Q1 condition subsets being respectively associated with the Q1 cells, Q1 being a positive integer greater than 1.

In one embodiment, the third receiver 1702 receives a third signaling: herein, the third signaling includes information being used to confirm successful access to the second serving cell.

In one embodiment, the third receiver 1702 receives a fifth signaling: herein, a third signaling is used to trigger the fifth signaling, the third signaling comprising information being used to confirm successful access to the second serving cell: the fifth signaling comprises at least a portion of the third signaling, a receiver of the fifth signaling being a maintenance base station of the second serving cell.

In one embodiment, the first triggering condition comprises that at least a measurement result for the second serving cell is greater than a first threshold: the first signaling comprises the first threshold: the first threshold is configured by a maintenance base station of the first serving cell, or, the first threshold is configured by a maintenance base station of the second serving cell.

In one embodiment, the third receiver 1702 transmits the first threshold; herein, the first threshold is configured by a maintenance base station of the second serving cell.

In one embodiment, as a response to a second triggering condition being satisfied, a third serving cell is disconnected and a second candidate configuration is applied, the second candidate configuration including configuration information for the first serving cell, the third serving cell being a SpCell: where the action of receiving the first signaling occurs before the second triggering condition being satisfied.

In one embodiment, a second signaling is received, the second signaling being used to indicate the first condition set: herein, the action of receiving the second signaling occurs after the second triggering condition being satisfied.

In one embodiment, as a response to the second triggering condition being satisfied, a receiver of the first signaling is synchronized to the first serving cell: a fourth signaling is transmitted: where the fourth signaling includes information that is used to confirm successful access to the first serving cell.

In one embodiment, the fourth signaling is used to trigger a sixth signaling, the sixth signaling comprising at least a portion of the fourth signaling, a receiver of the sixth signaling being a maintenance base station of the first serving cell.

In one embodiment, the second triggering condition comprises that at least a measurement result for the first serving cell is greater than a second threshold: the first signaling comprises the second threshold: the second threshold is configured by a maintenance base station of the third serving cell, or, the second threshold is configured by a maintenance base station of the first serving cell.

In one embodiment, a cell group identity of a cell group to which the first serving cell belongs is configured as a first integer, and a cell group identity of a cell group to which the second serving cell belongs is configured as the first integer.

In one embodiment, the first condition subset includes Q2 triggering conditions, and the second serving cell is one of Q2 cells, the Q2 triggering conditions being respectively associated with the Q2 cells, Q2 being a positive integer greater than 1.

In one embodiment, a second condition subset is evaluated after successful application of the first candidate configuration: herein, the second condition subset is a proper subset of the first condition set: the second condition subset is related to the second serving cell.

In one embodiment, the third transmitter 1701 comprises the antenna 420, the transmitter 418, the multi-antenna transmitting processor 471, the transmitting processor 416, the controller/processor 475 and the memory 476 in FIG. 4 of the present application.

In one embodiment, the third transmitter 1701 comprises the antenna 420, the transmitter 418, the multi-antenna transmitting processor 471 and the transmitting processor 416 in FIG. 4 of the present application.

In one embodiment, the third transmitter 1701 comprises the antenna 420, the transmitter 418 and the transmitting processor 416 in FIG. 4 of the present application.

In one embodiment, the third receiver 1702 comprises the antenna 420, the receiver 418, the multi-antenna receiving processor 472, the receiving processor 470, the controller/processor 475 and the memory 476 in FIG. 4 of the present application.

In one embodiment, the third receiver 1702 comprises the antenna 420, the receiver 418, the multi-antenna receiving processor 472 and the receiving processor 470 in FIG. 4 of the present application.

In one embodiment, the third receiver 1702 comprises the antenna 420, the receiver 418 and the receiving processor 470 in FIG. 4 of the present application.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things (IoT), RFID terminals, NB-IoT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP), and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first receiver, receiving a first signaling, the first signaling being used to indicate a first condition set, the first condition set including multiple triggering conditions; and
a first processor, as a response to a first triggering condition being satisfied, disconnecting from a first serving cell and applying a first candidate configuration, the first candidate configuration including configuration information for a second serving cell, the first serving cell and the second serving cell each being a SpCell;
wherein the first triggering condition being satisfied occurs after receiving the first signaling, the first triggering condition is a triggering condition in a first condition subset, and the first condition subset is a proper subset of the first condition set; the first condition subset is related to the first serving cell.

2. The first node according to claim 1, characterized in that the first condition set includes Q1 condition subsets, and the first serving cell is one of Q1 cells, the Q1 condition subsets being respectively associated with the Q1 cells, the Q1 being a positive integer greater than 1.

3. The first node according to claim 1, characterized in that the first triggering condition comprises that at least a measurement result for the second serving cell is greater than a first threshold: the first signaling comprises the first threshold: the first threshold is configured by a maintenance base station of the first serving cell, or, the first threshold is configured by a maintenance base station of the second serving cell.

4. The first node according to claim 1, characterized in comprising:
the first processor, as a response to a second triggering condition being satisfied, disconnecting from a third serving cell and applying a second candidate configuration, the second candidate configuration including configuration information for the first serving cell, the third serving cell being a SpCell:
wherein the action of receiving the first signaling occurs before the second triggering condition being satisfied.

5. The first node according to claim 4, characterized in comprising:
the first receiver, receiving a second signaling, the second signaling being used to indicate the first condition set:
wherein the action of receiving the second signaling occurs after the second triggering condition being satisfied.

6. The first node according to claim 4, characterized in that the second triggering condition comprises that at least a measurement result for the first serving cell is greater than a second threshold; the first signaling comprises the second threshold; the second threshold is configured by a maintenance base station of the third serving cell, or, the second threshold is configured by a maintenance base station of the first serving cell.

7. The first node according to claim 1, characterized in that a cell group identity of a cell group to which the first serving cell belongs is configured as a first integer, and a cell group identity of a cell group to which the second serving cell belongs is configured as the first integer.

8. The first node according to claim 1, characterized in comprising:
the first receiver, evaluating a second condition subset after successful application of the first candidate configuration;
wherein the second condition subset is a proper subset of the first condition set; the second condition subset is related to the second serving cell.

9. The first node according to claim 8, characterized in that the first signaling comprises the first information block; the first information block comprises at least one of a first identifier, the first candidate configuration or the second condition subset: the first identifier indicates the second serving cell: the first identifier is a non-negative integer.

10. The first node according to claim 1, characterized in that the first triggering condition includes an event A3, or the first triggering condition includes an event A4, or, the first triggering condition includes an event A5.

11. The first node according to claim 1, characterized in that before completing the application of the first candidate configuration, no triggering condition in any condition subset associated with the second serving cell in the first condition set is to be evaluated.

12. The first node according to claim 1, characterized in that after completing the application of the first candidate configuration, the configuration of the first serving cell is not deleted.

13. The first node according to claim 1, characterized in that after completing the application of the first candidate configuration, a triggering condition in a condition subset associated with the second serving cell in the first condition set is to be evaluated.

14. The first node according to claim 1, characterized in that the first condition set is for a PCell, the SpCell being the PCell; the first signaling is used to configure a candidate PCell.

15. The first node according to claim 1, characterized in that the first condition set is for a PSCell, the SpCell being the PSCell; the first signaling is used to configure CPC or CPA.

16. The first node according to claim 1, characterized in that the first signaling being used to indicate a first condition set includes: the first signaling indicating all conditions in the first condition set.

17. The first node according to claim 1, characterized in that the first signaling is a RRCReconfiguration message:
the first signaling indicates measurement identifiers respectively associated with each triggering condition among the multiple triggering conditions in the first condition set; and the first signaling indicates triggering events respectively associated with each triggering condition among the multiple triggering conditions in the first condition set.

18. The first node according to claim 1, characterized in that the first condition subset is associated with a first candidate cell set, and the second serving cell is one candidate cell in the first candidate cell set; the first condition subset includes at least one triggering condition, and each triggering condition in the first condition subset corresponds to one candidate cell in the first candidate cell set.

19. A method in a first node for wireless communications, comprising:
receiving a first signaling, the first signaling being used to indicate a first condition set, the first condition set including multiple triggering conditions; and
as a response to a first triggering condition being satisfied, disconnecting from a first serving cell and applying a first candidate configuration, the first candidate configuration including configuration information for a second serving cell, the first serving cell and the second serving cell each being a SpCell;
wherein the first triggering condition being satisfied occurs after receiving the first signaling, the first triggering condition is a triggering condition in a first condition subset, and the first condition subset is a proper subset of the first condition set: the first condition subset is related to the first serving cell.

20. A second node for wireless communications, comprising:
a first transmitter, transmitting a first signaling, the first signaling being used to indicate a first condition set, the first condition set including multiple triggering conditions:
wherein as a response to a first triggering condition being satisfied, a first serving cell is disconnected and a first candidate configuration is applied, the first candidate configuration including configuration information for a second serving cell, the first serving cell and the second serving cell each being a SpCell; the first triggering condition being satisfied occurs after receiving the first signaling, the first triggering condition is a triggering condition in a first condition subset, and the first condition subset is a proper subset of the first condition set; the first condition subset is related to the first serving cell.
